(19) United States
(12) Patent Application Publication
(10) Pub. No.: US 2005/0134909 A1
(43) Pub. Date: Jun. 23, 2005

(54) Distributed printing control device and print job distribution method

(76) Inventors: Toshihiro Shima, Nagano-ken (JP); Shinya Taniguchi, Nagano-ken (JP)

Correspondence Address: MARTINE PENILLA & GENCARELLA, LLP, 710 LAKEWAY DRIVE, SUITE 200, SUNNYVALE, CA, 94085, US

(21) Appl. No.: 10/996,840

(22) Filed: Nov. 24, 2004

(30) Foreign Application Priority Data
Nov. 26, 2003 (JP) 2003-395417
Jan. 20, 2004 (JP) 2004-11418
Jan. 29, 2004 (JP) 2004-20873

(51) Int. Cl. G06F 15/00

(52) U.S. Cl. 358/1.15

(57) ABSTRACT

A printing system of this invention utilizes a particular port number ‘19100’, instead of a general port number ‘9100’, for transmission of a print job from a client CL to a printer PRT1 having distributed printing control functions. A custom board network CNB of the printer PRT1 receives communication data DT0 including a print job with specification of a QT value representing ‘100 copies’ and a receiver port number ‘19100’ and transfers the received communication data DT0 to a distributed printing software program, which stands by at a port having the particular port number ‘19100’. An internal CPU of the custom network board CNB exerts the respective distributed printing control functions according to the distributed printing software program. The CPU specifies other printers PRT2 to PRT4 as well as the self printer PRT1 as distribution destination printers, changes the settings of the QT value included in the print job from ‘100 copies’ to ‘25 copies’ and the receiver port number from the particular number ‘19100’ to the general number ‘9100’, and sends communication data DT1 to DT4 including the print job with the changed settings to the respective distribution destination printers PRT1 to PRT4. This simple system effectively and efficiently achieves distributed printing.

### BACKGROUND OF THE INVENTION

1. Field of the Invention

The present invention relates to a technique of distributing a print job to at least one printing device connecting with a network and thereby attaining distributed printing.

2. Description of the Related Art

A printing system including multiple printers connected to an identical network has widely been used to enable each user to selectively use the multiple printers. A distributed printing technique has also been proposed to distribute a print job of printing multiple copies to plural printers for parallel printing and thereby complete printing in a short time period (see, for example, Japanese Patent Laid-Open Gazette No. 2002-215369). In the distributed printing system, an exclusive server for distributed printing is provided on the network to control distribution destinations of each print job and the number of prints copies.

A large-scaled system including the exclusive server is essential for the conventional distributed printing.

### SUMMARY OF THE INVENTION

The object of the invention is thus to eliminate the drawbacks of the prior art technique and to implement distributed printing by a simple system configuration.

In order to attain at least part of the above and the other related objects, the present invention is directed to a first distributed printing control device that distributes a print job sent via a network to at least one distribution destination printing device specified as a distribution destination among printing devices connecting with the network. When the print job is sent with specification of a particular port number, the first distributed printing control device distributes the print job to the at least one distribution destination printing device.

The first distributed printing control device of the invention does not require any special software program for distributed printing to be installed in a computer or any other equivalent device. Distributed printing is achieved by simply changing the setting of the port number in the computer to the particular port number in the process of transmission of the print job to the distributed printing control device. This arrangement significantly reduces the user's load. The distributed printing control device controls the whole distributed printing process. This simple system effectively implements distributed printing without any exclusive server.

The present invention is also directed to a second distributed printing control device that distributes a print job sent via a network to at least one distribution destination printing device specified as a distribution destination among printing devices connecting with the network. When the print job is sent according to a particular printing protocol, the second distributed printing control device distributes the print job to the at least one distribution destination printing device.

As in the first distributed printing control device, the second distributed printing control device of the invention does not require any special software program for distributed printing to be installed in a computer or any other equivalent device. Distributed printing is achieved by simply changing specification of the printing protocol to the particular printing protocol in the process of transmission of the print job to the distributed printing control device. This arrangement significantly reduces the user's load. The distributed printing control device controls the whole distributed printing process. This simple system effectively implements distributed printing without any exclusive server.

The present invention is further directed to a third distributed printing control device that distributes a print job sent via a network to at least two distribution destination printing devices specified as distribution destinations among printing devices connecting with the network. When the print job includes print copy number information and the print copy number information represents ‘n’ copies, where n is an integer of not less than 2, the third distributed printing control device sets distributed copy numbers to be distributed to the at least two distribution destination printing devices, such that a sum of the distributed copy numbers is equal to the ‘n’ copies. The third distributed printing control device changes the print number copy information in the print job to settings of the distributed copy numbers and distributes the print job with the changed settings to the at least two distribution destination printing devices.

The third distributed printing control device readily achieves distributed printing by simply changing only the print copy number information included in the print job and distributing the print job with the changed settings to the respective distribution destination printing devices. A CPU included in the distributed printing control device is accordingly not required to have the high processing capacity. This desirably reduces the total manufacturing cost.

In one preferable embodiment of the invention, the third distributed printing control device sets the distributed copy numbers to be distributed to the at least two distribution destination printing devices as equally as possible.

Such setting enables distribution of the required number of print copies as equal as possible to the respective distribution destination printing devices.

In another preferable embodiment of the invention, the third distributed printing control device acquires information on an expendable used in each of the at least two distribution destination printing devices from the at least two distribution destination printing devices and sets the distributed copy numbers based on the acquired information.

This arrangement ensures efficient distributed printing according to the states of the expendable in the respective distribution destination printing devices.

In this preferable embodiment, when the acquired information on the expendable represents a remaining quantity or a remaining life of the expendable, the third distributed printing control device sets a greater distributed copy number to a distribution destination printing device having a greater remaining quantity or a greater remaining life of the expendable.

This arrangement desirably reduces the possibility of an accidental stop of the distribution destination printing device due to complete consumption of the expendable or the end of the life of the expendable in the course of distributed printing, thus ensuring efficient use of the respective distribution destination printing devices.

In still another preferable embodiment of the invention, the third distributed printing control device acquires information on a performance of each of the at least two distribution destination printing devices and sets the distributed copy numbers based on the acquired information.

This arrangement ensures efficient distributed printing according to the performances of the respective distribution destination printing devices.

In this preferable embodiment, when the acquired information on the performance represents a processing speed of the distribution destination printing device, the third distributed printing control device sets a greater distributed copy number to a distribution destination printing device having a higher processing speed.

This arrangement desirably shortens the total time required for distributed printing.

In another preferable embodiment of the invention, in response to reception of the print copy number information, the third distributed printing control device changes settings of the print copy number information and starts distribution of the print job, even prior to completion of reception of the whole print job.

This arrangement significantly accelerates a start of printing in the respective distribution destination printing devices.

It is preferable that the distributed printing control device is built in or connected to a particular printing device. In one preferable embodiment, the distributed printing control device built in or connected to the particular printing device retrieves a printing device that is an identical model with a model of the particular printing device and is ready for printing, among the printing devices connecting with the network, and specifies the retrieved printing device as the distribution destination printing device.

When the distributed printing control device is built in or connected to the particular printing device, the print job sent to the distributed printing control device has been set for the particular printing device. Specification of the distribution destination printing devices that are of the identical model with the model of the particular printing device accordingly achieves adequate distributed printing of the print job without any data conversion of the print job.

In another preferable embodiment, the distributed printing control device built in or connected to the particular printing device has a distribution destination specification file. The distributed printing control device retrieves a printing device that is an identical model with a model of the particular printing device and is ready for printing, in a range defined by specification in the distribution destination specification file among the printing devices connecting with the network, and specifies the retrieved printing device as the distribution destination printing device.

The distribution destination specification file restricts the range of retrieval for the possible printing devices of distribution destination.

In this preferable embodiment, the distributed printing control device built in or connected to the particular printing device acquires model information on the model of the particular printing device from the particular printing device during a time period between power-on and start of the retrieval.

When the distributed printing control device in the power off state is newly built in or connected to another particular printing device of a different model, this arrangement ensures adequate acquisition of the model information on the model of another particular printing device after a power-on operation.

The present invention is also directed to a fourth distributed printing control device that distributes a print job sent via a network to at least one distribution destination printing device specified as a distribution destination among printing devices connecting with the network. The fourth distributed printing control device includes a print job storage module that stores the print job and a control module.

The control module stores the print job into the print job storage module when the print job is sent with specification of a particular port number. In the case of complete storage of the whole sent print job into the print job storage module, the control module specifies the at least one distribution destination printing device among the printing devices connecting with the network and distributes the print job stored in the print job storage module to the specified at least one distribution destination printing device, so that each of the at least one distribution destination printing device implements printing of one copy.

The fourth distributed printing control device controls the whole distributed printing process. This simple system effectively implements distributed printing without any exclusive server.

When storage of the whole sent print job into the print job storage module is complete, the fourth distributed printing control device specifies the distribution destination printing devices and distributes the stored print job to the respective distribution destination printing devices. Each distribution destination printing device then implements printing of one copy. Even when some error arises to lead to failed printing in any of the distribution destination printing devices, this is failure of only one copy.

The fourth distributed printing control device of the invention does not require any special software program for distributed printing to be installed in a computer or any other equivalent device. Distributed printing is achieved by simply changing the setting of the port number in the computer to the particular port number in the process of transmission of the print job to the distributed printing control device. This arrangement significantly reduces the user's load.

In one preferable embodiment of the invention, the first distributed printing control device or the fourth distributed printing control device sends and distributes the print job with specification of a port number, which is different from the particular port number, to the at least one distribution destination printing device.

The particular printing device including the distributed printing control device may be selected as one of the distribution destination printing devices. The port number specified in the process of distribution of the print job to the particular printing device is different from the particular port number. This arrangement ensures discrimination of the distributed print job from the original print job sent with specification or the particular port number, thus preventing infinite redistribution of the print job.

The present invention is further directed to a fifth distributed printing control device that distributes a print job sent via a network to at least one distribution destination printing device specified as a distribution destination among printing devices connecting with the network. The fifth distributed printing control device includes a print job storage module that stores the print job and a control module.

The control module stores the print job into the print job storage module when the print job is sent according to a particular printing protocol. In the case of complete storage of the whole sent print job into the print job storage module, the control module specifies the at least one distribution destination printing device among the printing devices connecting with the network and distributes the print job stored in the print job storage module to the specified at least one distribution destination printing device, so that each of the at least one distribution destination printing device implements printing of one copy.

Like the fourth distributed printing control device, the fifth distributed printing control device controls the whole distributed printing process. This simple system effectively implements distributed printing without any exclusive server.

When storage of the whole sent print job into the print job storage module is complete, the fifth distributed printing control device specifies the distribution destination printing devices and distributes the stored print job to the respective distribution destination printing devices. Each distribution destination printing device then implements printing of one copy. Even when some error arises to lead to failed printing in any of the distribution destination printing devices, this is failure of only one copy.

The fifth distributed printing control device of the invention does not require any special software program for distributed printing to be installed in a computer or any other equivalent device. Distributed printing is achieved by simply changing specification of the printing protocol to the particular printing protocol in the process of transmission of the print job to the distributed printing control device. This arrangement significantly reduces the user's load.

In one preferable embodiment of the invention, the second distributed printing control device or the fifth distributed printing control device sends and distributes the print job according to a printing protocol, which is different from the particular printing protocol, to the at least one distribution destination printing device.

The particular printing device including the distributed printing control device may be selected as one of the distribution destination printing devices. The printing protocol used for distribution of the print job to the particular printing device is different from the particular printing protocol. This arrangement ensures discrimination of the distributed print job from the original print job sent according to the particular printing protocol, thus preventing infinite redistribution of the print job.

In one preferable embodiment of the distributed printing control device of the invention, when the print job includes print copy number information and the print copy number information represents ‘m’ copies, where m is an integer of not less than 2, the control module repeats specification of the at least one distribution destination printing device among the printing devices connecting with the network and distribution of the print job to the specified at least one distribution destination printing device until an accumulated number of copies printed by the at least one distribution destination printing device reaches the ‘m’ copies.

Specification of the distribution destination printing devices among the printing device connecting with the network and distribution of the print job to the specified distribution destination printing devices are repeated until the accumulated number of print copies reaches the ‘m’ copies. Such repetition enables printing devices that have no error and are ready for printing to be selected as new distribution destination printing devices every time and distributes the print job to the selected distribution destination printing devices with no error. This arrangement gives the required number of copies specified by the print copy number information included in the received print job as the accumulated number of copies printed by the respective distribution destination printing devices.

In another preferable embodiment of the distributed printing control device of the invention, the control module retrieves a printing device that is in an online state but is not receiving nor printing any print job among the printing devices connecting with the network as at least one possible printing device of distribution destination, and selects the at least one distribution destination printing device among the at least one possible printing device of distribution destination.

Such specification of the distribution destination printing devices desirably excludes the printing devices that are in the error state or the printing devices that may fall into the error state from the possible printing devices of distribution destination. This arrangement effectively prevents repeated transmission of the print job to the printing device that has failed in printing.

In still another preferable embodiment of the distributed printing control device of the invention, in the case of incomplete storage of the whole sent print job into the print job storage module, when the print job includes print copy number information and the print copy number information represents ‘m’ copies, where m is an integer of not less than 2, the control module specifies the at least one distribution destination printing device among the printing devices connecting with the network, sets distributed copy numbers to be distributed to the at least one distribution destination printing device such that a sum of the distributed copy numbers is equal to the ‘m’ copies, and distributes the print job to the specified at least one distribution destination printing device, so that each distribution destination printing device implements printing of the distributed copy number.

Even in the case of incomplete storage of the whole sent print job into the print job storage module, the print job is distributed to the respective distribution destination printing devices, such that each distribution destination printing device implements printing of the distributed copy number. The sum of the distributed copy numbers is equal to the ‘m’ copies. This arrangement gives the required number of copies specified by the print copy number information included in the received print job as the total number of copies printed by the respective distribution destination printing devices.

It is preferable that the distributed printing control device is built in or connected to at least one particular printing device among the printing devices connecting with the network.

It is also preferable that the distributed printing control device built in or connected to the particular printing device specifies the particular printing device as the distribution destination printing device.

The particular printing device is selectable as the distribution destination printing device. This desirably widens the selectable range of the distribution destination printing devices.

In the distributed printing control device built in or connected to the particular printing device, it is preferable that the control module extracts at least one printing device of an identical model with a model of the particular printing device among the printing devices connecting with the network, and selects the at least one distribution destination printing device among the extracted at least one printing device of the identical model.

When the distributed printing control device is built in or connected to the particular printing device, the print job sent to the distributed printing control device has been set for the particular printing device. Specification of the distribution destination printing devices that are of the identical model with the model of the particular printing device accordingly achieves adequate distributed printing of the print job without any data conversion of the print job.

In another preferable structure, the distributed printing control device built in or connected to the particular printing device has a distribution destination specification file. The control module extracts the at least one printing device of the identical model with the model of the particular printing device in a range defined by specification in the distribution destination specification file among the printing devices connecting with the network.

The distribution destination specification file restricts the range of extraction for the possible printing devices of distribution destination.

The present invention is not restricted to the distributed printing control devices having any of the above arrangements, but is also actualized by diversity of other applications, for example, printing devices including the distributed printing control device and corresponding print job distribution methods. Other possible applications include computer programs that are used to attain the methods and the devices, recording media and program products in which such computer programs are recorded, and data signals that include such computer programs and are embodied in carrier waves.

In the applications of the invention as the computer programs and the recording media in which the computer programs are recorded, the invention may be given as whole programs to control printing devices or as partial programs to exert only the characteristic functions of the invention. Available examples of the recording media include flexible disks, CD-ROMs, DVD-ROMs, magneto-optical disks, IC cards, ROM cartridges, punched cards, prints with barcodes or other codes printed thereon, internal storage devices (memories like RAMs and ROMs) and external storage devices of the computer, and diversity of other computer readable media.

These and other objects, features, aspects, and advantages of the present invention will become more apparent from the following detailed description of the preferred embodiments with the accompanied drawings.

### BRIEF DESCRIPTION OF THE DRAWINGS

FIG. 1 schematically illustrates the configuration of a printing system including a printer PRT1 in a first embodiment of the invention;

FIG. 2 conceptually shows the structure of communication data including a print job;

FIG. 3 mainly shows the structure of the printer PRT1 included in the printing system of FIG. 1;

FIG. 4 is a flowchart showing a processing routine executed by the main functional blocks of the printer PRT1 in the first embodiment;

FIG. 5 shows print job data opened by an editor;

FIG. 6 is a flowchart showing the details of the process of retrieving and specifying the distribution destination printers executed at step S110 in the flowchart of FIG. 4;

FIG. 7 shows the contents of a distribution destination specification file;

FIG. 8 mainly shows the structure of the printer PRT1 included in a printing system in a second embodiment of the invention;

FIG. 9 is a flowchart showing a distributed copy number setting routine executed by the printer PRT1 in a third embodiment of the invention;

FIG. 10 shows the contents of a distribution destination specification file;

FIG. 11 is a flowchart showing a distributed copy number setting routine executed by the printer PRT1 in a fourth embodiment of the invention;

FIG. 12 schematically shows paper trays set in distribution destination printers;

FIG. 13 schematically illustrates the configuration of a printing system including the printer PRT1 in a fifth embodiment of the invention;

FIG. 14 mainly shows the structure of the printer PRT1 included in the printing system of FIG. 13;

FIG. 15 is a flowchart showing a processing routine executed by the main functional blocks of the printer PRT1 in the fifth embodiment;

FIG. 16 is a flowchart showing the details of the first distributed printing process executed at step S1118 in the flowchart of FIG. 15;

FIG. 17 is a flowchart showing the details of the common preprocessing executed at step S1202 in the flowcharts of FIGS. 16 and 18;

FIG. 18 is a flowchart showing the details of the second distributed printing process executed at step S1120 in the flowchart of FIG. 15; and

FIG. 19 mainly shows the structure of the printer PRT1 in a sixth embodiment of the invention.

### DESCRIPTION OF THE PREFERRED EMBODIMENTS

Some modes of carrying out the invention are described below as preferred embodiments in the following sequence:

A. First Embodiment

A1. System Configuration

A2. Structure of Printer

A3. General Printing Process

A4. Distributed Printing Process

A5. Effects of Embodiment

B. Second Embodiment

B1. Structure of Printer

B2. General Printing Process

B3. Distributed Printing Process

B4. Effects of Embodiment

C. Third Embodiment

C1. Distributed Printing Process

C2. Effects of Embodiment

D. Fourth Embodiment

D1. Distributed Printing Process

D2. Effects of Embodiment

E. Fifth Embodiment

E1. System Configuration

E2. Structure of Printer

E3. Distributed Printing Process

E4. Effects of Embodiment

F. Sixth Embodiment

F1. Structure of Printer

F2. Distributed Printing Process

F3. Effects of Embodiment

G. Modifications

A. First Embodiment

A1. System Configuration

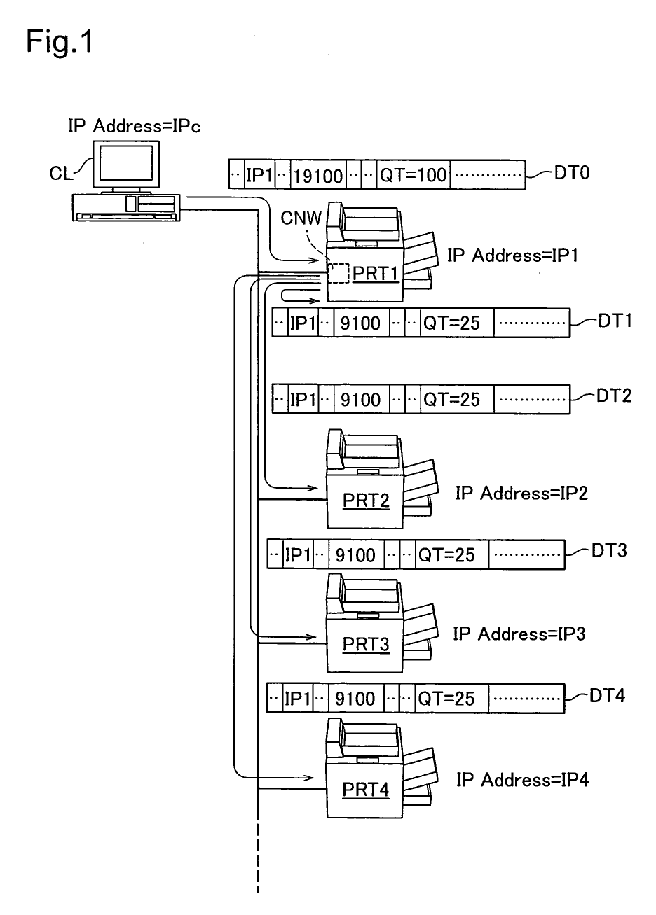

FIG. 1 schematically illustrates the configuration of a printing system including a printer PRT1 in a first embodiment of the invention. As illustrated, in this printing system, a client PC (hereafter referred to as the client) CL and multiple printers PRT1 through PRT4 are connected to a local area network (LAN). Communication between the respective devices is on the basis of the TCP/IP protocol, and fixed IP addresses are allocated to the respective devices. For convenience of explanation, it is here assumed that an IP address ‘IPc’ is allocated to the client CL and that IP addresses ‘IP1’ to ‘IP4’ are respectively allocated to the printers PRT1 to PRT4. Strictly speaking, these IP addresses are not set in the client CL and the printers PRT1 to PRT4, but are set at nodes in the TCP/IP network (for example, network boards connected to the network for TCP/IP communication).

A custom network board CNB is mounted on the printer PRT1 among these printers PRT1 to PRT4. The custom network board CNB has distributed printing control functions to distribute a received print job to other printers and implement distributed printing, and is equivalent to the distributed printing control device of the invention. Standard network boards (not shown) are mounted on the other printers PRT2 to PRT4.

In the illustrated example of FIG. 1, communication data DT0 including a print job is sent from the client CL to the printer PRT1.

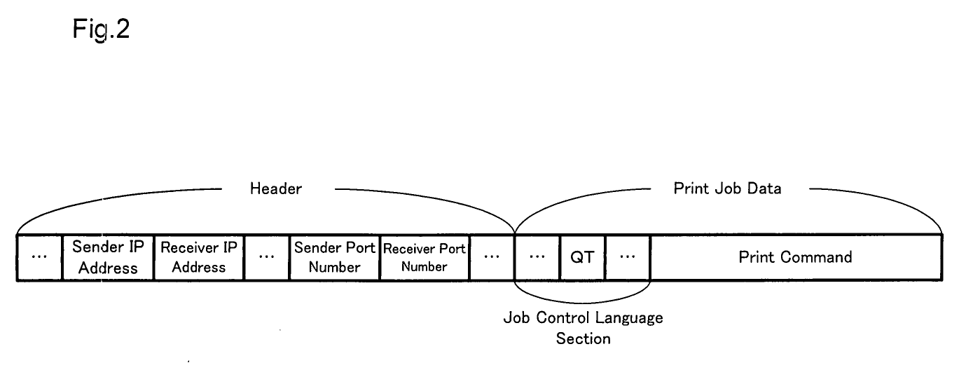

FIG. 2 conceptually shows the structure of communication data including a print job. As shown in FIG. 2, the communication data is mainly divided into a header and print job data.

The header includes an IP address allocated to a sender device as a sender of the communication data (sender IP address), a port number for specifying the software program of the sender in the sender device (sender port number), an IP address allocated to a receiver device as a receiver of the communication data (receiver IP address), and a port number for specifying the software program of the receiver in the receiver device (receiver port number). The communication data transmitted from the software program in the sender device is sent to the receiver device having the specified receiver IP address. The receiver device receives the communication data and transfers the print job data included in the received communication data to the software program standing by at a port having the specified receiver port number.

The print job data includes a job control language section and a print command. The job control language section includes a QT value representing the number of print copies as the print copy number information.

The TCP/IP protocol generally transmits communication data in the form of packets. In the actual transmission, the series of print job data are time-shared and are sent as multiple time-shared data with the identical header.

Referring back to FIG. 1, the communication data DT0 includes ‘IP1’ as the receiver IP address, ‘19100’ as the receiver port number, and ‘100 copies’ as the QT value (that is, the number of print copies).

The printing protocol used in this embodiment is a non-procedural protocol. A port number ‘9100’ is generally allocated to the non-procedural protocol. As one of the characteristics of the invention, however, the technique of this embodiment uses a particular port number ‘19100’ instead of the general number ‘9100’ to send the print job from the client CL to the printer PRT1 having the distributed printing control functions.

The custom network board CNB mounted on the printer PRT1 receives the communication data DT0 and transfers the print job data included in the received communication data DT0 to the software program standing by at a port having the receiver port number ‘19100’. In this embodiment, the software program standing by at the port with the port number ‘19100’ is a distributed printing software program to attain the distributed printing control functions. An internal CPU of the custom network board CNB exerts the respective functions according to the distributed printing software program. The CPU specifies the printers PRT2 through PRT4 and the self printer PRT1 as distribution destination printers, changes the QT value included in the print job data from ‘100 copies’ to ‘25 copies’ and the receiver port number from ‘19100’ to ‘9100’, and sends communication data DT1 through DT4 respectively including divisional print jobs to the specified distribution destination printers PRT1 to PRT4.

For example, the communication data DT2 includes ‘IP2’ as the receiver IP address, ‘9100’ as the receiver port number, and ‘25 copies’ as the QT value.

The standard network board mounted on the printer PRT2 receives the communication data DT2 and transfers the print job data included in the received communication data DT2 to the software program standing by at a port having the port number ‘9100’. As mentioned above, the port number ‘9100’ is generally allocated to the non-procedural printing protocol. The print job data is accordingly transferred to a print control software program in the printer PRT2, which then executes printing according to the received divisional print job.

The other printers PRT3 and PRT4 and the printer PRT1 having the distributed printing control functions similarly execute printing according to the received divisional print jobs.

Each of the printers PRT1 through PRT4 executes printing of ‘25 copies’. The printing system thus completes distributed printing of the total of ‘100 copies’.

A2. Structure of Printer

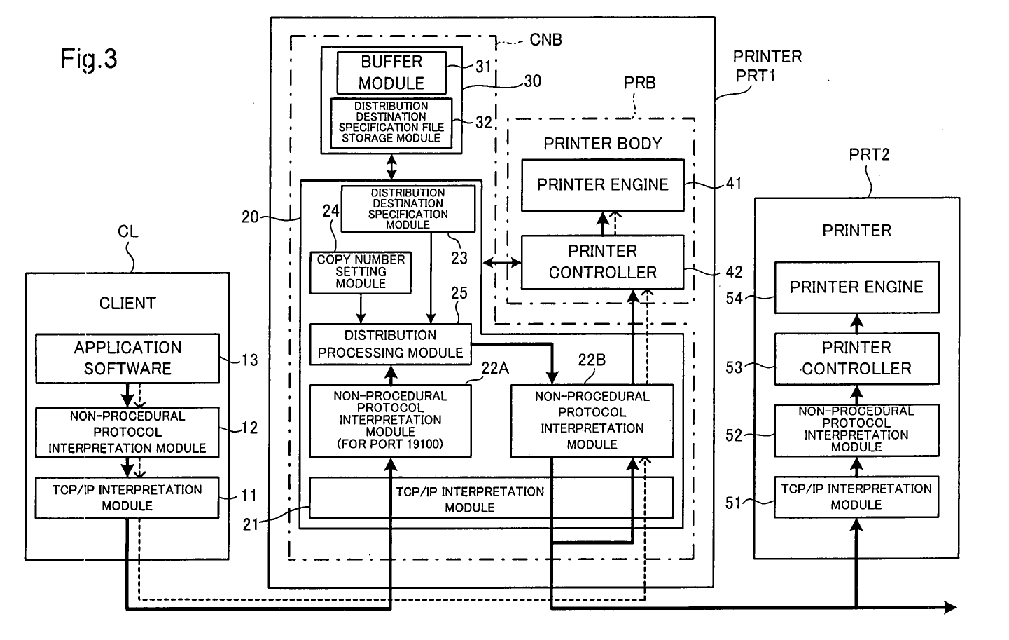

FIG. 3 mainly shows the structure of the printer PRT1 included in the printing system of FIG. 1. The printer PRT1 has a printer body PRB and the custom network board CNB. The printer body PRB mainly includes a printer engine 41 and a printer controller 42. The printer engine 41 is a mechanism driven to actually implement printing. The printer controller 42 receives the print job data from the custom network board CNB and controls the printer engine 41 according to the received print job data to implement printing.

The custom network board CNB, which is characteristic of the invention, mainly includes a CPU 20 and a memory 30. Other elements of the custom network board CNB including a communication interface that takes charge of network communication are omitted for the simplicity of illustration.

The CPU 20 reads the distributed printing software program and other required programs from the memory 30 and executes the programs to work as respective functional blocks illustrated in FIG. 3. These functional blocks may be actualized by the hardware configuration, instead of the software configuration. This CPU 20 is equivalent to the control module of the invention.

Among the functional blocks, a TCP/IP interpretation module 21 interprets the TCP/IP protocol and establishes communication with the outside via the network. The TCP/IP interpretation module 21 detects a receiver IP address and a receiver port number included in received communication data, while attaching a sender IP address and a sender port number to communication data to be sent. Non-procedural protocol interpretation modules 22A and 22B interpret the non-procedural printing protocol. In the structure of this embodiment, for convenience of explanation, it is assumed that the non-procedural protocol interpretation module 22B functions when the receiver port number is the general number ‘9100’ and that the non-procedural protocol interpretation module 22A functions when the receiver port number is the particular number ‘19100’.

A distribution destination specification module 23 retrieves available printers as distribution destinations of distributed printing on the LAN and specifies the retrieved available printers as distribution destination printers. A copy number setting module 24 refers to the specified total number of print copies and sets distributed copy numbers to be distributed to the respective distribution destination printers. A distribution processing module 25 rewrites the QT value representing the number of print copies and distributes divisional print job data respectively including the rewritten QT values to the respective distribution destination printers.

The memory 30 has a buffer module 31 and a distribution destination specification file storage module 32 to store the programs and variety of data. The buffer module 31 temporarily stores the received print job data, but has a relatively small storage capacity that is not sufficient to store all the received print job data simultaneously. The distribution destination specification file storage module 32 stores a distribution destination specification file. The distribution destination specification file is used to restrict and specify in advance desired printers as possible printers of distribution destination for distributed printing among multiple printers connected to the LAN. When such restriction and specification is not demanded, no file is stored in the distribution destination specification file storage module 32.

In FIG. 3, the client CL includes a TCP/IP interpretation module 11 and a non-procedural protocol interpretation module 12 as functional blocks and application software 13. The printer PRT2 includes a TCP/IP interpretation module 51 and a non-procedural protocol interpretation module 52 as functional blocks, a printer controller 53, and a printer engine 54. The non-procedural protocol interpretation module 12 of the client CL and the non-procedural protocol interpretation module 52 of the printer PRT2 have the same functions as those of the non-procedural protocol interpretation module 22B of the printer PRT1 that deals with the communication data sent with the general number ‘9100’ as the receiver port number. The TCP/IP interpretation module 11 of the client CL and the TCP/IP interpretation module 51 of the printer PRT2 have the same functions as those of the TCP/IP interpretation module 21 of the printer PRT1. The printer controller 53 and the printer engine 54 of the printer PRT2 have the same functions as those of the printer controller 42 and the printer engine 41 of the printer PRT1.

The printers PRT3 and PRT4 included in the printing system of FIG. 1 have the same structure as that of the printer PRT2 shown in FIG. 3.

A3. General Printing Process

A general printing process is described briefly, prior to description of a distributed printing process, which is characteristic of the invention. In an example of the general printing process, a print job is sent from the client CL to the printer PRT1 and is executed by only the printer PRT1. In this case, the print job is transferred by a route shown by the dotted arrows in FIG. 3. The printing protocol is set to the non-procedural protocol in a printer driver (not shown) of the client CL.

In response to the user's print command to the client CL, the application software 13 in the client CL sends a print job via the non-procedural protocol interpretation module 12 and the TCP/IP interpretation module 11 to the printer PRT1. The non-procedural protocol interpretation module 12 sends communication data including the print job according to the non-procedural printing protocol. The TCP/IP interpretation module 11 specifies ‘IP1’ allocated to the printer PRT1 as the receiver IP address of the communication data and ‘9100’ generally allocated to the non-procedural protocol as the receiver port number of the communication data.

In the printer PRT1, the TCP/IP interpretation module 21 receives the communication data according to the receiver IP address ‘IP1’ included in the communication data. Since the receiver port number included in the received communication data is ‘9100’, the TCP/IP interpretation module 21 transfers the received communication data to the non-procedural protocol interpretation module 22B that deals with communication data sent with the general number ‘9100’. The non-procedural protocol interpretation module 22B receives the communication data including the print job and transfers the print job to the printer controller 42 according to the non-procedural protocol. The printer controller 42 reads the specified number of print copies from the QT value included in the print job data and controls the printer engine 41 to print the specified number of print copies.

A4. Distributed Printing Process

The distributed printing process, which is characteristic of the invention, is described in detail. When the user turns on power of the printer PRT1, the printer body PRB and the custom network board CNB are activated. The distribution destination specification module 23 acquires the model name of the self printer PRT1. In the concrete procedure, the distribution destination specification module 23 specifies the IP address ‘IP1’ of the self printer PRT1 as the receiver IP address and inquires about the model name according to SNMP (Simple Network Management Protocol). The CPU 20 receives a response to the inquiry about the model name from the printer controller 42 via a bus.

On the above assumptions, in one example, a print job is sent from the client CL to the printer PRT1 and is subjected to the distributed printing by the other printers PRT2 to PRT4 as well as the self printer

For distributed printing, the user confirms that the printing protocol is set to the non-procedural protocol in the printer driver of the client CL and changes the setting of the port number from the general number ‘9100’ to the particular number ‘19100’. In this embodiment, setting the general number ‘9100’ selects the general printing process, while setting the particular number ‘19100’ selects the distributed printing process.

When the user issues a print command including specification of ‘100 copies’ as the number of print copies to the client CL, the application software 13 in the client CL sends a print job with the setting of the QT value, which represents the number of print copies, to ‘100 copies’ via the non-procedural protocol interpretation module 12 and the TCP/IP interpretation module 11 to the printer PRT1. The non-procedural protocol interpretation module 12 sends communication data including the print job according to the non-procedural printing protocol. The TCP/IP interpretation module 11 specifies ‘IP1’ allocated to the printer PRT1 as the receiver IP address of the communication data and the particular number ‘19100’, instead of the general number ‘9100’, as the receiver port number of the communication data.

The communication data DT0 shown in FIG. 1 is then sent from the client CL to the printer PRT1. The communication data DT0 includes ‘IP1’ as the receiver IP address, ‘19100’ as the receiver port number, and ‘100 copies’ as the QT value (that is, the number of print copies).

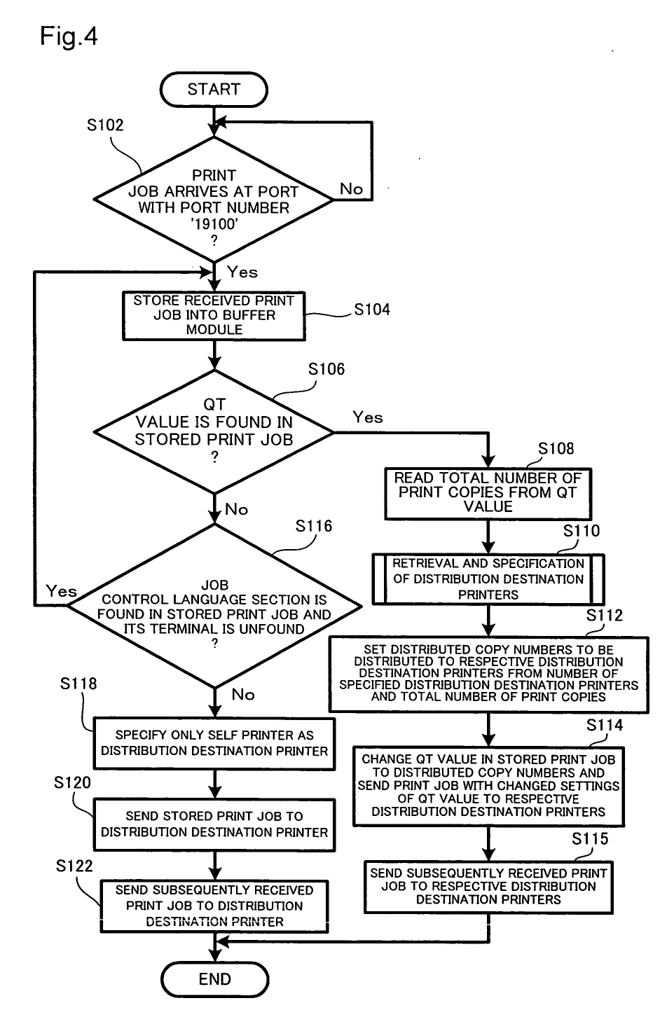

FIG. 4 is a flowchart showing a processing routine executed by the main functional blocks of the printer PRT1. More specifically this processing routine is executed by the distribution processing module 25, the distribution destination specification module 23, and the copy number setting module 24.

In the printer PRT1, the TCP/IP interpretation module 21 receives the communication data DT0 according to the receiver IP address ‘IP1’ included in the communication data DT0. Since the receiver port number included in the received communication data DT0 is ‘19100’, the TCP/IP interpretation module 21 transfers the received communication data DT0 to the non-procedural protocol interpretation module 22A that deals with communication data sent with the particular number ‘19100’, instead of the non-procedural protocol interpretation module 22B.

The distribution processing module 25 stands by until a print job arrives at a port having the particular port number ‘19100’ (step S102). The non-procedural protocol interpretation module 22A receives the communication data including the print job and transfers the received print job data to the distribution processing module 25, which stands by at the port having the particular port number ‘19100’, according to the non-procedural protocol.

The distribution processing module 25 successively receives the print job data from its head and stores the received print job data into the buffer module 31 (step S104).

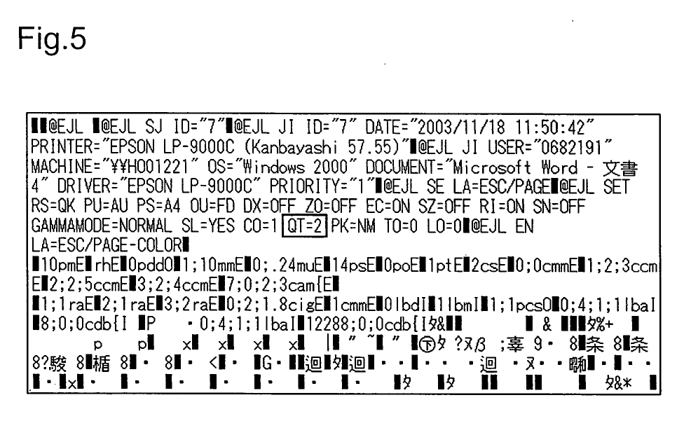

FIG. 5 shows an example of print job data opened by an editor. As shown in FIG. 5, the former half of the print job data is a job control language section, and the rear half is a print command. The job control language section includes the QT value representing the number of print copies as the print copy number information. In this illustrated example, ‘QT=2’ means that the QT value (the number of print copies) is set equal to ‘2 copies’.

The distribution processing module 25 keeps storing the received print job data into the buffer module 31 until the QT value is found in the stored print job data (step S106). When the QT value is found, the distribution processing module 25 stops storing the print job data into the buffer module 31 and reads the required total number of print copies from the QT value (step S108). In this example, ‘100 copies’ is set to the QT value (the number of print copies) (‘QT=100’) as described previously. The distribution processing module 25 extracts ‘100 copies’ as the total number of print copies to be processed by distributed printing.

The distribution destination specification module 23 retrieves available printers for distributed printing among the multiple printers connecting with the LAN, and specifies the retrieved available printers as distribution destination printers (step S110).

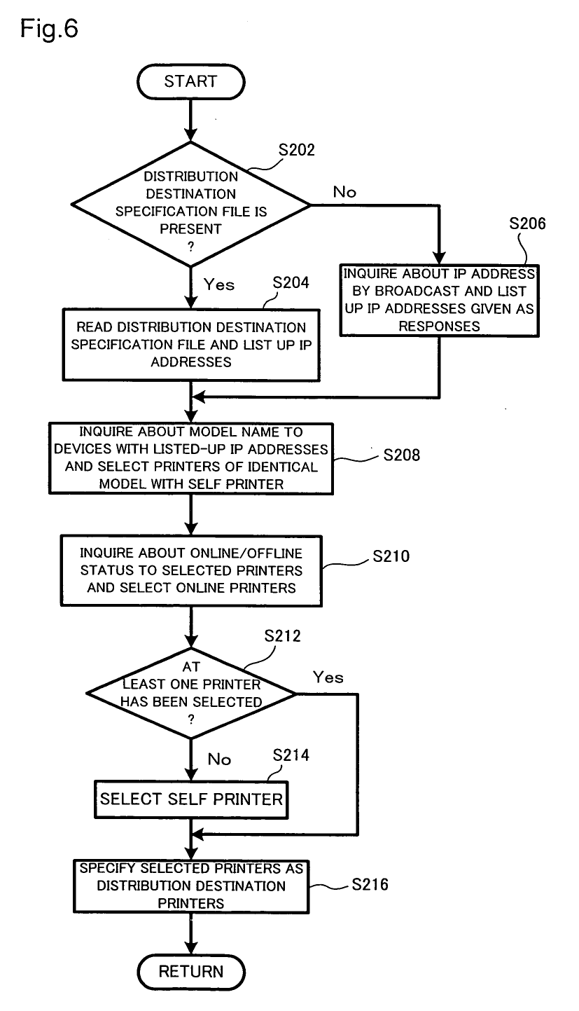

FIG. 6 is a flowchart showing the details of the process of retrieving and specifying the distribution destination printers executed at step S110 in the flowchart of FIG. 4. The distribution destination specification module 23 first detects the presence or the absence of a distribution destination specification file in the distribution destination specification file storage module 32 (step S202). The storage of the distribution destination specification file means that desired printers have been specified in advance as possible printers of distribution destination for distributed printing.

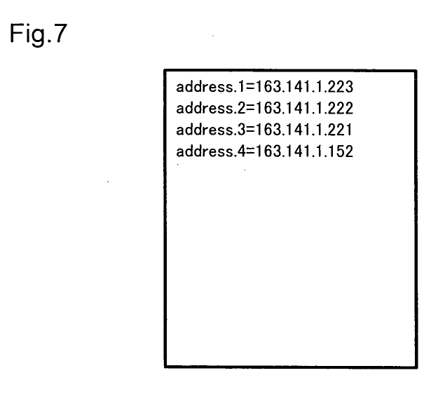

FIG. 7 shows the contents of a distribution destination specification file. As shown in FIG. 7, the distribution destination specification file includes a list of IP addresses allocated to possible printers of distribution destination for distributed printing. For example, the service personnel may connect a setting computer to the printer PRT1 at the time of installation and initialization of the printer PRT1 and install and store the distribution destination specification file in the distribution destination specification file storage module 32. The distribution destination specification file may otherwise be installed via the LAN. When the self printer PRT1 is chosen as one of the distribution destinations for distributed printing, the IP address ‘IP1’ of the self printer PRT1 is to be written in the distribution destination specification file.

When the distribution destination specification file is present in the distribution destination specification file storage module 32, the distribution destination specification module 23 reads the stored distribution destination specification file to list up the IP addresses of the selected printers (step S204).

When the distribution destination specification file is absent in the distribution destination specification file storage module 32, on the other hand, the distribution destination specification module 23 utilizes SNMP or another suitable protocol to inquire about the IP addresses of the respective devices connecting with the LAN by broadcast and lists up the IP addresses given as responses (step S206).

The distribution destination specification module 23 utilizes SNMP to inquire about the model name to the respective devices having the listed-up IP address and selects the printers of the same model as that of the self printer PRT1 by referring to the responses on the model name (step S208). The printers of the same model as that of the self printer PRT1 are selected as possible printers of distribution destination. Such selection enables the printers specified as distribution destinations to adequately implement distributed printing without any data conversion of the print job. This standardizes the qualities of resulting prints by the respective distribution destination printers, for example, the resolution and the font, as well as specification of color printing and duplex printing.

As mentioned previously, the distribution destination specification module 23 has already acquired the model name of the printer PRT1 at the power-on time of the printer PRT1 and selects the printers of the same model as that of the self printer PRT1 based on the acquired model name.

The inquiry about the model name is made to the devices having the IP addresses specified in the distribution destination specification file. There is still some possibility that an IP address written in the distribution destination specification file may be newly allocated to a printer of a different model from the model of the self printer PRT1 or to any non-printer device, after preparation of the distribution destination specification file. Accordingly demanded is confirmation that the specified IP addresses are still given to the printers of the same model as that of the self printer PRT1. This inquiry simultaneously confirms that the devices having the IP addresses specified in the distribution destination specification file are currently powered on to be accessible via the network.

The distribution destination specification module 23 utilizes SNMP or another suitable protocol to inquire about the current status, that is, the online or offline status, to the selected possible printers of distribution destination and selects the online printers by referring to the responses on the status (step S210). This selection excludes unavailable printers that are currently out of paper, out of toner, out of ink, in paper jam, or in any other trouble, from the possible printers of distribution destination.

When no printer has been selected as the possible printer of distribution destination (step S212), the distribution destination specification module 23 selects the self printer PRT1 as the possible printer of distribution destination (step S214).

The distribution destination specification module 23 specifies the finally selected printers as distribution destination printers (step S216). In the illustrated example of FIG. 1, the total of four printers, that is, the self printer PRT1 and the other printers PRT2 through PRT4 are specified as the distribution destination printers. The CPU 20 exits from this processing routine shown in the flowchart of FIG. 6 and goes back to the processing routine shown in the flowchart of FIG. 4.

At step S112 in the flowchart of FIG. 4, the copy number setting module 24 sets the distributed copy numbers to be distributed to the respective distribution destination printers from the number of the distribution destination printers specified at step S110 and the total number of print copies obtained at step S108. The procedure of this embodiment sets the distributed copy numbers to be distributed to the respective distribution destination printers as equally as possible. The sum of the distributed copy numbers should naturally be equal to the required total number of print copies.

In the illustrated example of FIG. 1, the number of the specified distribution destination printers is 4 and the required total number of print copies is ‘100 copies’. The distributed copy numbers to be distributed to the respective distribution destination printers are accordingly set equal to ‘25 copies’.

The number of the specified distribution destination printers and the total number of print copies naturally make it impossible to completely equalize the distributed copy numbers to be distributed to the respective distribution destination printers. Based on this fact, the distributed copy numbers are set according to the following procedure.

The copy number setting module 24 sets a distributed copy number ax to be distributed to an x-th printer among ‘s’ distribution destination printers according to Equation (1) given below, where m denotes the total number of print copies:

$${a}_{x} = int ( \frac{m}{s} ) + ( x \leq ( m - int ( \frac{m}{s} ) \times s ) ) ? 1 \text{:} 0 \qquad ( 1 )$$

In Equation (1), the second term on the right side ‘( . . . ≦ . . . )?1:0’ is set equal to ‘1’ when the inequality in parenthesis is satisfied, while being set equal to ‘0’ when the inequality in parenthesis is not satisfied.

For example, when the number of distribution destination printers ‘s’ is 4 (s=4) and the total number of print copies ‘m’ is 102 copies (m=102), Equation (1) is rewritten to Equation (2):

$$\begin{matrix}{a}_{x} = int ( \frac{102}{4} ) + ( x \leq ( 102 - int ( \frac{102}{4} ) \times 4 ) ) ? 1 \text{:} 0 \\ = 25 + ( x \leq 2 ) ? 1 \text{:} 0\end{matrix} \qquad ( 2 )$$

The settings of the distributed copy number ax to the four distribution destination printers are accordingly given as:

First printer: a1=25+1=26 copies

Second printer: a2=25+1=26 copies

Third printer: a3=25+0=25 copies

Fourth printer: a4=25+0=25 copies

The distribution processing module 25 changes only the QT value in the print job data stored in the buffer module 31 to the settings of the distributed copy number ax to be distributed to the respective distribution destination printers and sends the print job data with the changed settings of the QT value to the respective distribution destination printers (step S114). In the illustrated example of FIG. 1, the distributed copy numbers to be distributed to the respective distribution destination printers are all set equal to ‘25 copies’. The QT value included in the print job data is accordingly changed from ‘QT=100’ to ‘QT=25’, and the print job data with the changed settings of the QT value are sent to the four distribution destination printers. The distribution processing module 25 then resumes storing the received print job data into the buffer module 31 and successively sends the print job data subsequently received and temporarily stored in the buffer module 31 to the respective distribution destination printers (step S115).

The distribution processing module 25 changes only the settings of the QT value included in the received print job and sends the received print job with the changed settings of the QT value via the non-procedural protocol interpretation module 22B and the TCP/IP interpretation module 21 to the respective distribution destination printers. The non-procedural protocol interpretation module 22B sends the communication data including the print job according to the non-procedural printing protocol. The TCP/IP interpretation module 21 specifies the IP addresses of the respective distribution destination printers as the receiver IP addresses of the communication data and the port number ‘9100’ generally allocated to the non-procedural protocol, instead of the received particular port number ‘19100’, as the receiver port number.

In the illustrated example of FIG. 1, the printers PRT1 through PRT4 are specified as the distribution destination printers. The communication data DT1 through DT4 sent to the respective distribution destination printers PRT1 through PRT4 include the settings of the receiver IP address, the receiver port number, and the QT value as:

Communication data DT1 to printer PRT1→‘IP1’, ‘9100’, ‘25 copies’

Communication data DT2 to printer PRT2→‘IP2’, ‘9100’, ‘25 copies’

Communication data DT3 to printer PRT3→‘IP3’, ‘9100’, ‘25 copies’

Communication data DT4 to printer PRT4→‘IP4’, ‘9100’, ‘25 copies’

In the printer PRT2 as one of the specified distribution destination printers, as shown in FIG. 3, the TCP/IP interpretation module 51 receives the communication data DT2 with the receiver port number ‘9100’ according to the receiver IP address ‘IP2’ included in the communication data DT2 and transfers the communication data DT2 including a print job to the non-procedural protocol interpretation module 52. The non-procedural protocol interpretation module 52 receives the communication data including the print job and transfers the print job to the print controller 53 according to the non-procedural protocol. The printer controller 53 reads the required number of print copies ‘25 copies’ from the QT value included in the print job data and controls the printer engine 54 to print the specified number of print copies ‘25 copies’ according to the print job.

Each of the other printers PRT3 and PRT4 specified as the distribution destination printers similarly implements printing of the specified number of print copies ‘25 copies’ according to the received print job.

In the self printer PRT1 as one of the specified distribution destination printers, the TCP/IP interpretation module 21 receives the communication data DT1 according to the receiver IP address ‘IP1’ included in the communication data DT1. Since the receiver port number included in the received communication data DT1 is ‘9100’, the TCP/IP interpretation module 21 transfers the communication data DT1 including a print job to the non-procedural protocol interpretation module 22B that deals with communication data sent with the general port number ‘9100’ in the same manner as the general printing process. The non-procedural protocol interpretation module 22B receives the communication data including the print job and transfers the print job to the printer controller 42 according to the non-procedural protocol. The printer controller 42 reads the specified number of print copies ‘25 copies’ from the QT value included in the print job data and controls the printer engine 41 to print the specified number of print copies according to the print job.

In this manner, the printers PRT1 through PRT4 specified as the distribution destination printers respectively implement printing of ‘25 copies’. The printing system totally completes distributed printing of ‘100 copies’.

Referring back to the flowchart of FIG. 4, when it is determined at step S106 that the QT value is not found in the print job data stored in the buffer module 31, the distribution processing module 25 determines whether the job control language section is found in the print job data stored in the buffer module 31 and whether a terminal end of the job control language section has still been unfound (step S116).

When the job control language section is not found in the stored print job data, this means that the print job data does not include the job control language section. When the QT value is not found but the job control language section is found and its terminal end has already been found, this means that the job control language section does not include the QT value. In such cases, there is no possibility of finding the QT value in the received print job data. The program accordingly proceeds to next step S118. The distribution destination specification module 23 specifies only the self printer PRT1 as the distribution destination printer at step S118. The absence of the QT value means that the required total number of print copies is unknown. The distribution processing module 25 can not complete the distributed printing process and accordingly switches to the general printing process with only the self printer PRT1. The distribution processing module 25 sends the print job data stored in the buffer module 31 to the self printer PRT1 specified as the distribution destination printer (step S120). The distribution processing module 25 then successively sends the subsequently received print job data to the self printer PRT1 specified as the distribution destination printer (step S122).

The distribution processing module 25 sends the received print job via the non-procedural protocol interpretation module 22B and the TCP/IP interpretation module 21 to the self printer PRT1. The non-procedural protocol interpretation module 22B sends the communication data including the print job according to the non-procedural printing protocol. The TCP/IP interpretation module 21 specifies the IP address ‘IP1’ of the self printer PRT1 as the receiver IP address of the communication data and the port number ‘9100’ generally allocated to the non-procedural protocol, instead of the received particular port number ‘19100’, as the receiver port number.

In the self printer PRT1, the TCP/IP interpretation module 21 receives the sent communication data according to the receiver IP address ‘IP1’ included in the communication data. Since the receiver port number included in the received communication data is ‘9100’, the TCP/IP interpretation module 21 transfers the communication data including a print job to the non-procedural protocol interpretation module 22B that deals with communication data sent with the general port number ‘9100’. The non-procedural protocol interpretation module 22B receives the communication data including the print job and transfers the print job to the printer controller 42 according to the non-procedural protocol. The print job data does not include the QT value, so that the printer controller 42 controls the printer engine 41 to print only one copy according to the print job. The printer PRT1 accordingly implements printing of only one copy.

A5. Effects of Embodiment

As described above, in the printing system of the first embodiment, the printer PRT1 having the distributed printing control functions controls the whole distributed printing process. This simple system effectively implements distributed printing without any exclusive server.

The system of this embodiment does not require any special software program for distributed printing to be installed in the client CL. Distributed printing is achieved by simply changing the setting of the port number in the printer driver from the general port number ‘9100’ generally allocated to the non-procedural protocol to the particular port number ‘19100’. This arrangement significantly reduces the user's load.

The receiver port number in the communication data received by each distribution destination printer is the general number ‘9100’ generally allocated to the non-procedural protocol. The distribution destination printer can thus implement printing, regardless of general printing or distributed printing.

The printer PRT1 having the distributed printing control functions selectively uses the particular receiver port number ‘19100’ of the communication data as the trigger of the distributed printing control and the general receiver port number ‘9100’ of the communication data to be sent to the respective distribution destination printers. The self printer PRT1 may be specified as one of the distribution destination printers and receive the communication data with the print job sent to itself. Even in this case, the port number included in the received communication data is ‘9100’, which is different from the trigger of the distributed printing control. The printer PRT1 accordingly does not infinitely redistribute the print job division distributed to itself. Similarly when multiple custom network boards having the distributed printing control functions are present in an identical network this arrangement effectively prevents meaningless to-and-fro distribution between the multiple custom network boards.

The printer PRT1 having the distributed printing control functions changes only the QT value as the print copy number information included in the received print job and sends the communication data with the changed settings of only the QT value to the respective distribution destination printers to achieve distributed printing. The CPU 20 included in the custom network board CNB is accordingly not required to have the high processing capacity. This desirably reduces the total manufacturing cost.

As soon as the QT value is found in the print job data successively received and stored in the buffer module 31, the printer PRT1 having the distributed printing control functions changes the QT value and starts sending the print job data with the changed settings of the QT value to the respective distribution destination printers. This arrangement significantly accelerates the start of printing at the respective distribution destination printers, compared with the conventional system that starts sending the print job data to the respective distribution destination printers after completion of receiving all the print job data sent from the client CL.

B. Second Embodiment

The technique of the first embodiment uses the identical non-procedural printing protocol but different port numbers, that is, the general number ‘9100’ and the particular number ‘19100’, in the process of sending the print job from the client CL to the printer PRT1 having the distributed printing control functions and in the process of sending the print job from the printer PRT1 to the specified distribution destination printers to achieve distributed printing. The technique of a second embodiment uses different printing protocols in the process of sending the print job from the client CL to the printer PRT1 having the distributed printing control functions and in the process of sending the print job from the printer PRT1 to the specified distribution destination printers to achieve distributed printing.

B1. Structure of Printer

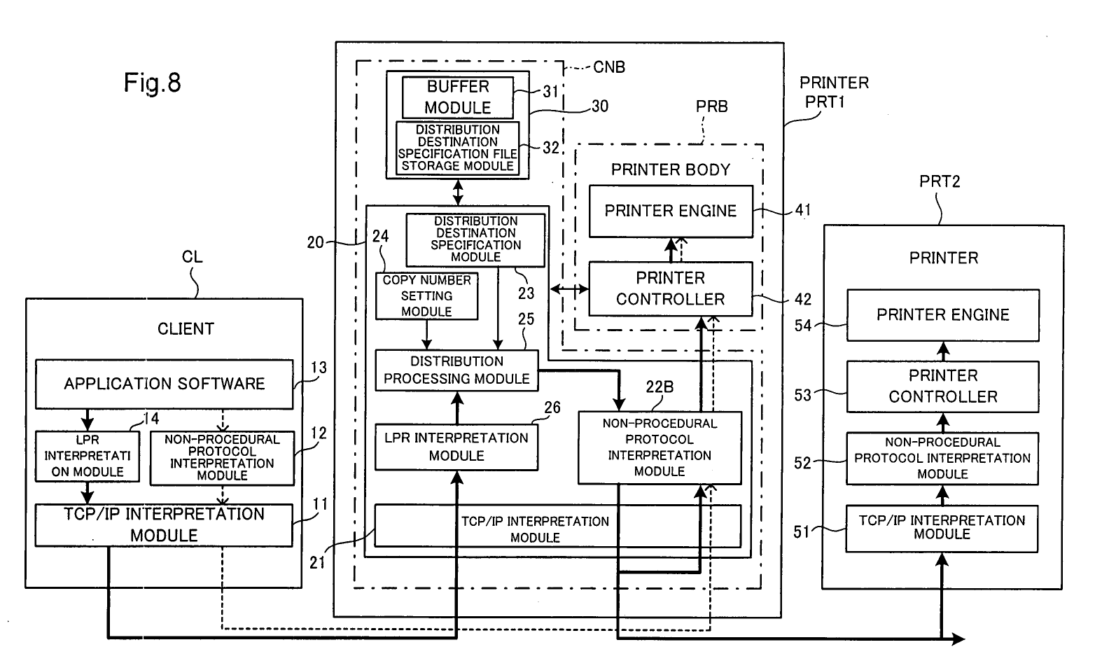

FIG. 8 mainly shows the structure of the printer PRT1 in the second embodiment of the invention. The structure of the printer PRT1 of the second embodiment shown in FIG. 8 is similar to the structure of the printer PRT1 of the first embodiment shown in FIG. 3, except that the non-procedural protocol interpretation module 22A is replaced by an LPR interpretation module 26 (the non-procedural protocol interpretation module 22B is kept unchanged) and that the client CL correspondingly has an LPR interpretation module 14.

In the structure of FIG. 8, both the LPR interpretation modules 26 and 14 interpret a printing protocol LPR (Line PRinter daemon protocol).

B2. General Printing Process

A general printing process is described briefly, prior to description of a distributed printing process executed in the second embodiment. In an example of the general printing process, a print job is sent from the client CL to the printer PRT1 and is executed by only the printer PRT1. In this case, the print job is transferred by a route shown by the dotted arrows in FIG. 8. The printing protocol is set to the non-procedural protocol in a printer driver (not shown) of the client CL.

In response to the user's print command to the client CL, the application software 13 in the client CL sends a print job via the non-procedural protocol interpretation module 12 and the TCP/IP interpretation module 11 to the printer PRT1. The non-procedural protocol interpretation module 12 sends communication data including the print job according to the non-procedural printing protocol. The TCP/IP interpretation module 11 specifies ‘IP1’ allocated to the printer PRT1 as the receiver IP address of the communication data.

In the printer PRT1, the TCP/IP interpretation module 21 receives the communication data according to the receiver IP address ‘IP1’ included in the communication data. The non-procedural protocol interpretation module 22B receives the communication data including the print job and transfers the print job to the printer controller 42 according to the non-procedural protocol. The printer controller 42 reads the specified number of print copies from the QT value included in the print job data and controls the printer engine 41 to print the specified number of print copies.

B3. Distributed Printing Process

The distributed printing process executed in the second embodiment is described briefly. In order to implement distributed printing, the user changes the setting of the printing protocol from the non-procedural protocol to the LPR in the printer driver of the client CL. The technique of the second embodiment changes over the setting of the printing protocol to selectively execute the general printing process according to the non-procedural protocol or the distributed printing process according to the LPR.

When the user issues a print command including specification of ‘100 copies’ as the number of print copies to the client CL, the application software 13 in the client CL sends a print job with the setting of the QT value, which represents the number of print copies, to ‘100 copies’ via the LPR interpretation module 14 and the TCP/IP interpretation module 11 to the printer PRT1. The LPR interpretation module 14 sends communication data including the print job according to the printing protocol LPR. The TCP/IP interpretation module 11 specifies ‘IP1’ allocated to the printer PRT1 as the receiver IP address of the communication data.

In the printer PRT1, the TCP/IP interpretation module 21 receives the communication data according to the receiver IP address ‘IP1’ included in the communication data. The LPR interpretation module 26 receives the communication data including the print job and transfers the print job data to the distribution processing module 25 according to the printing protocol LPR.

The series of processing executed in the second embodiment to specify the distribution destination printers and the distributed copy numbers after the transfer of the print job data to the distribution processing module 25 is identical with that of the first embodiment and is thus not specifically described here. In this example, the printers PRT1 through PRT4 are specified as the distribution destination printers and the ‘25 copies’ is set to the distributed copy numbers to be distributed to the respective distribution destination printers.

The distribution processing module 25 changes only the settings of the QT value included in the received print job and sends the received print job with the changed settings of the QT value via the non-procedural protocol interpretation module 22B, instead of the LPR interpretation module 26, and the TCP/IP interpretation module 21 to the respective distribution destination printers. The non-procedural protocol interpretation module 22B sends the communication data including the print job according to the non-procedural printing protocol. The TCP/IP interpretation module 21 specifies the IP addresses of the respective distribution destination printers as the receiver IP addresses of the communication data.

In the printer PRT2 as one of the specified distribution destination printers, as shown in FIG. 8, the TCP/IP interpretation module 51 receives the communication data according to the receiver IP address ‘IP2’ included in the communication data and transfers the communication data including a print job to the non-procedural protocol interpretation module 52. The non-procedural protocol interpretation module 52 receives the communication data including the print job and transfers the print job to the print controller 53 according to the non-procedural protocol. The printer controller 53 reads the required number of print copies ‘25 copies’ from the QT value included in the print job data and controls the printer engine 54 to print the specified number of print copies ‘25 copies’ according to the print job.

Each of the other printers PRT3 and PRT4 specified as the distribution destination printers similarly implements printing of the specified number of print copies ‘25 copies’ according to the received print job.

In the self printer PRT1 as one of the specified distribution destination printers, the TCP/IP interpretation module 21 receives the communication data according to the receiver IP address ‘IP1’ included in the communication data sent to itself The non-procedural protocol interpretation module 22B receives the communication data including the print job and transfers the print job to the printer controller 42 according to the non-procedural protocol. The printer controller 42 reads the specified number of print copies ‘25 copies’ from the QT value included in the print job data and controls the printer engine 41 to print the specified number of print copies according to the print job.

In this manner, the printers PRT1 through PRT4 specified as the distribution destination printers respectively implement printing of ‘25 copies’. The printing system totally completes distributed printing of ‘100 copies’.

B4. Effects of Embodiment

As described above, like the printing system of the first embodiment, in the printing system of the second embodiment, the printer PRT1 having the distributed printing control functions controls the whole distributed printing process. This simple system effectively implements distributed printing without any exclusive server.

The system of this embodiment does not require any special software program for distributed printing to be installed in the client CL. Distributed printing is achieved by simply changing the setting of the printing protocol in the printer driver from the non-procedural protocol to the LPR. This arrangement significantly reduces the user's load.

The printer PRT1 having the distributed printing control functions changes over the setting of the printing protocol between the LPR as the trigger of the distributed printing control and the non-procedural protocol used for transmission to the distribution destination printers. Even when the self printer PRT1 is specified as one of the distribution destination printers and sends the print job to itself, the non-procedural protocol selected as the printing protocol in this state is different from the trigger of the distributed printing control. This arrangement effectively prevents the printer PRT1 from infinitely redistributing the print job division distributed to itself.

C3. Third Embodiment

In the first and the second embodiments discussed above, the copy number setting module 24 sets the distributed copy numbers to be distributed to the respective distribution destination printers as equally as possible. In a printing system of a third embodiment, the copy number setting module 24 inquires about the remaining quantity of toner to the respective distribution destination printers and sets the distributed copy numbers to be distributed to the respective distribution destination printers by referring to the responses on the remaining quantity of toner.

The structures of the printers and the general printing process in the third embodiment are substantially identical with those of the first or the second embodiment and are thus not specifically described here.

C1. Distributed Printing Process

A distributed printing process executed in the third embodiment is described. Only the partial flow of the distributed printing process is different from the distributed printing process of the first embodiment or the second embodiment and is described in detail.

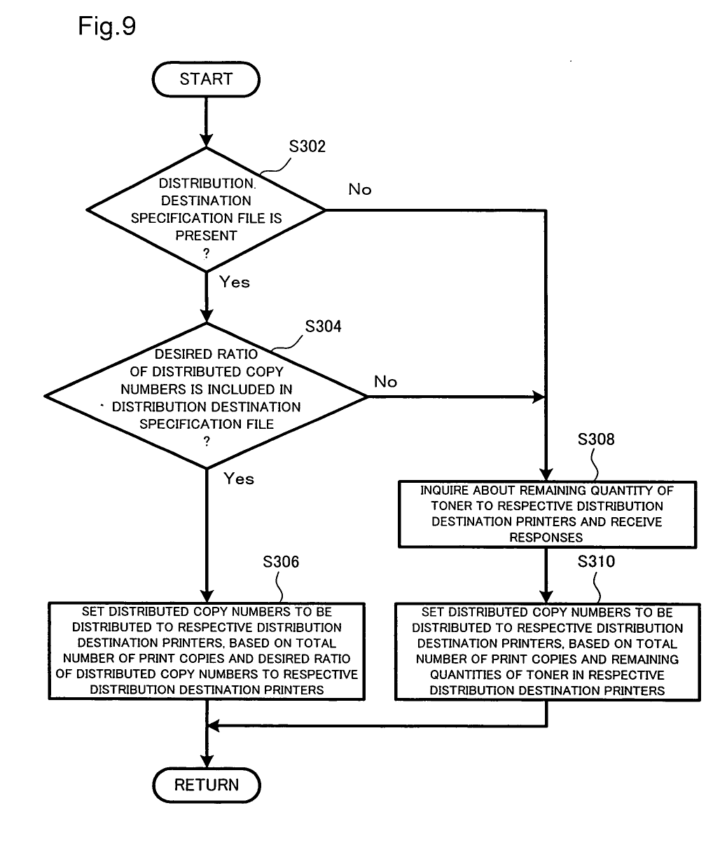

In the processing routine of the first embodiment shown in the flowchart of FIG. 4, the distribution destination specification module 23 retrieves available printers as distribution destinations among multiple printers connecting with the LAN and specifies the retrieved available printers as the distribution destination printers at step S110. The copy number setting module 24 then sets the distributed copy numbers to be distributed to the respective distribution destination printers as equally as possible, from the number of the specified distribution destination printers and the required total number of print copies at step S112. In the third embodiment, the copy number setting module 24 executes a distributed copy number setting routine shown in the flowchart of FIG. 9, in place of the processing at step S112.

FIG. 9 is the flowchart showing the distributed copy number setting routine executed by the printer PRT1 in the third embodiment of the invention. The copy number setting module 24 first detects the presence or the absence of a distribution destination specification file in the distribution destination specification file storage module 32 (step S302). When the distribution destination specification file is stored in the distribution destination specification file storage module 32, the copy number setting module 24 reads the distribution destination specification file from the distribution destination specification file storage module 32 and determines whether the ratio of the distributed copy numbers is written in the distribution destination specification file (step S304). The distribution destination specification file includes desired printers specified in advance as possible printers of distribution destination among the multiple printers connecting with the LAN. In the structure of this embodiment, the distribution destination specification file may also include a desired ratio of the distributed copy numbers to be distributed to the respective printers specified as the possible printers of distribution destination.

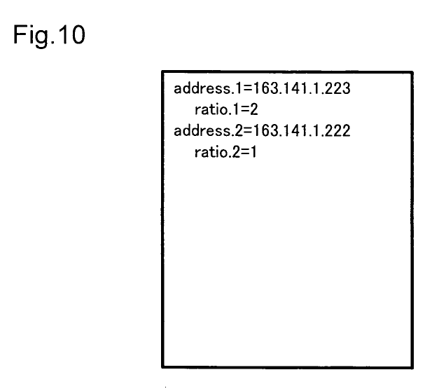

FIG. 10 shows the contents of a distribution destination specification file. The distribution destination specification file shown in FIG. 10 includes a list of IP addresses allocated to possible printers of distribution destination for distributed printing and a desired ratio of distributed copy numbers in pairs. In this illustrated distribution destination specification file, printers having an IP address ‘163.141.1.233’ and having an IP address ‘163.141.1.222’ are specified as the distribution destinations for distributed printing. The ratio of 2 to 1 is set as the desired ratio of the distributed copy number to be distributed to the former printer to the distributed copy number to be distributed to the latter printer.

The method of storing the distribution destination specification file into the distribution destination specification file storage module 32 is similar to the method of the first embodiment for storing the distribution destination specification file shown in FIG. 7. When the self printer PRT1 is chosen as one of the distribution destinations for distributed printing and specification of the desired ratio of the distributed copy numbers is demanded, the IP address ‘IP1’ of the self printer PRT1 and the rate of the distributed copy number to be distributed to the self printer PRT1 are to be written in the distribution destination specification file.

When the desired ratio of the distributed copy numbers is included in the distribution destination specification file, the copy number setting module 24 sets the distributed copy numbers to be distributed to the respective distribution destination printers, based on the total number of print copies obtained at step S108 in the flowchart of FIG. 4 and the ratio of the distributed copy numbers to the respective distribution destination printers (step S306). The sum of the distributed copy numbers should naturally be equal to the required total number of print copies.

For example, the two printers written in the distribution destination specification file of FIG. 10 are specified as the distribution destination printers at step S110 in the flowchart of FIG. 4, and the total number of print copies obtained at step S108 is ‘90 copies’. The desired ratio of 2 to 1 is set to the ratio of the distributed copy number to be distributed to the printer having the IP address ‘163.141.233’ to the distributed copy number to be distributed to the printer having the IP address ‘163.141.1.222’. The copy number setting module 24 accordingly sets ‘60 copies’ to the distributed copy number to be distributed to the former printer and ‘30 copies’ to the distributed copy number to be distributed to the latter printer.

The total number of print copies and the ratio of the distributed copy numbers may give some remainder. In such cases, the copy number setting module 24 adequately distributes the remainder to some distribution destination printers. In any case, the distributed copy numbers should be set to make the sum of the distributed copy numbers to be distributed to the respective distribution destination printers equal to the required total number of print copies.

When the distribution destination specification file is absent in the distribution destination specification file storage module 32 at step S302 or when the desired ratio of the distributed copy numbers is not specified in the distribution destination specification file at step S304, on the other hand, the copy number setting module 24 utilizes SNMP or another adequate protocol via the LAN to inquire about the remaining quantity of toner as the expendable to the respective distribution destination printers specified at step S110 in the flowchart of FIG. 4 and receive responses to the inquiry (step S308). The printer generally has the functions of monitoring the remaining quantities of expendables, for example, the remaining quantity of toner. Each distribution destination printer thus immediately gives information on the remaining quantity of toner in response to the inquiry made by the copy number setting module 24.

The copy number setting module 24 then sets the distributed copy numbers to be distributed to the respective distribution destination printers, based on the total number of print copies obtained at step S108 in the flowchart of FIG. 4 and the information on the remaining quantity of toner obtained from the respective distribution destination printers (step S310). The sum of the distributed copy numbers should naturally be equal to the required total number of print copies.

For example, the printers PRT2 and PRT3 shown in FIG. 1 are specified as distribution destination printers at step S110 in the flowchart of FIG. 4. At step S308 in the flowchart of FIG. 9, the copy number setting module 24 inquires about the remaining quantity of toner to the specified distribution destination printers. The remaining quantity of toner is ‘30%’ in the printer PRT2, while the remaining quantity of toner is double, that is, ‘60%’, in the printer PRT3.

When the total number of print copies obtained at step S108 is ‘120 copies’, the copy number setting module 24 sets ‘40 copies’ to the distributed copy number to be distributed to the printer PRT2 and ‘80 copies’ to the distributed copy number to be distributed to the printer PRT3. In this manner, the copy number setting module 24 sets the distributed copy numbers to be distributed to the specified distribution destination printers according to the remaining quantities of toner in the respective distribution destination printers. The less distributed copy number is set to the printer having the less remaining quantity of toner, while the greater distributed copy number is set to the printer having the greater remaining quantity of toner.

In general, the copy number setting module 24 sets a distributed copy number ax to be distributed to an x-th printer among ‘s’ distribution destination printers according to Equation (3) given below, where ‘m’ denotes the total number of print copies and tx denotes the remaining quantity of toner in the x-th printer:

$${a}_{x} = m \times ( \frac{{t}_{x}}{{\sum }_{x = 1}^{s} {t}_{x}} ) \qquad ( 3 )$$

The total number of print copies and the remaining quantities of toner may give some remainder in the calculation of Equation (3). As in the case of setting the desired ratio of the distributed copy numbers described above, the copy number setting module 24 adequately distributes the remainder to some distribution destination printers. In any case, the distributed copy numbers should be set to make the sum of the distributed copy numbers to be distributed to the respective distribution destination printers equal to the required total number of print copies ‘m’.

After the copy number setting module 24 sets the distributed copy numbers to be distributed to the respective distribution destination printers, the distribution processing module 25 changes the settings of only the QT value in the print job data stored in the buffer module 31 to the distributed copy numbers to be distributed to the respective distribution destination printers and sends the print job data with the changed settings to the respective distribution destination printers at step S114 in the flowchart of FIG. 4.

The other series of processing executed in the third embodiment is identical with the processing of the first embodiment or the second embodiment and is not specifically described here.

C2. Effects of Embodiment

As described above, the technique of the third embodiment sets the distributed copy numbers to be distributed to the specified distribution destination printers according to the remaining quantities of toner in the respective distribution destination printers. The less distributed copy number is set to the printer having the less remaining quantity of toner, while the greater distributed copy number is set to the printer having the greater remaining quantity of toner. This arrangement effectively reduces the possibility that any distribution destination printer runs out of toner and can not complete printing after the start of distributed printing, thus ensuring efficient use of the respective distribution destination printers.

D. Fourth Embodiment

In the printing system of the third embodiment, the copy number setting module 24 inquires about the remaining quantity of toner to the respective distribution destination printers and sets the distributed copy numbers based on the responses. In a printing system of a fourth embodiment, the copy number setting module 24 inquires about the presence or the absence of papers in paper trays, instead of the remaining quantity of toner, to the respective distribution destination printers and sets the distributed copy numbers to be distributed to the respective distribution destination printers based on the responses.

The structures of the printers and the general printing process in the fourth embodiment are substantially identical with those of the first or the second embodiment and are thus not specifically described here.

D1. Distributed Printing Process

A distributed printing process executed in the fourth embodiment is described. Only the partial flow of the distributed printing process is different from the distributed printing process of the first embodiment or the second embodiment and is described in detail.

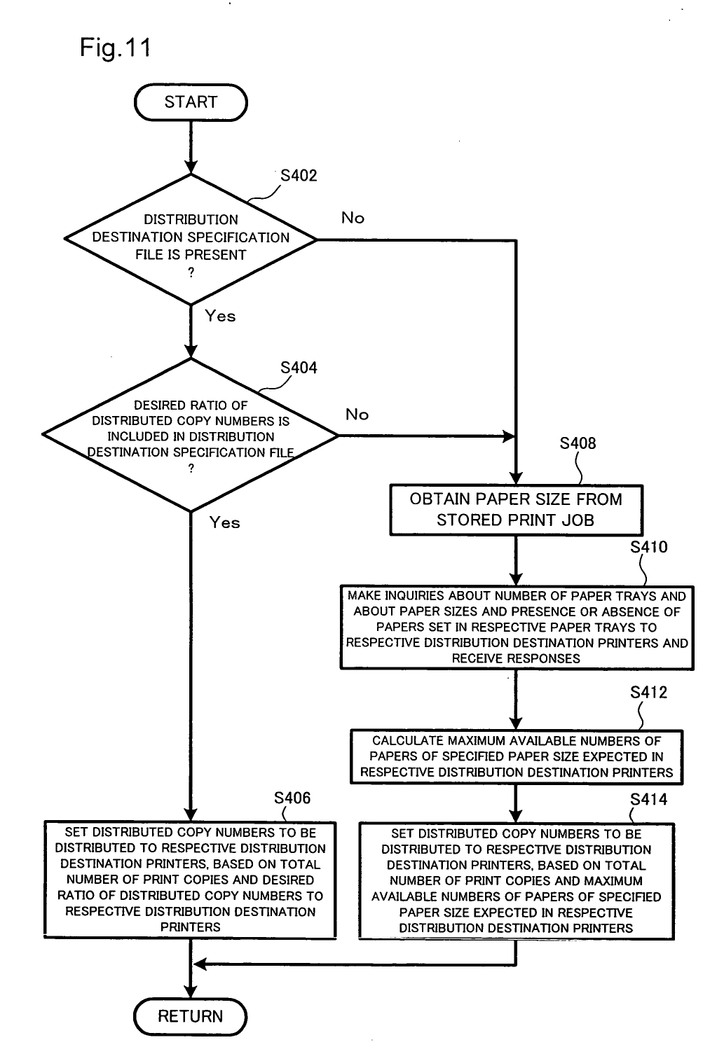

In the printing system of the fourth embodiment, the distribution destination specification module 23 retrieves available printers as distribution destinations among multiple printers connecting with the LAN and specifies the retrieved available printers as the distribution destination printers at step S110 in the flowchart of FIG. 4. The copy number setting module 24 then executes a distributed copy number setting routine shown in the flowchart of FIG. 11, in place of the processing at step S112.

FIG. 11 is the flowchart showing the distributed copy number setting routine executed by the printer PRT1 in the fourth embodiment of the invention. The processing of steps S402, S404, and S406 in this processing routine is identical with the processing of steps S302, S304, and S306 in the flowchart of FIG. 9 and is thus not specifically described here.

When the distribution destination specification file is absent in the distribution destination specification file storage module 32 at step S402 or when the desired ratio of the distributed copy numbers is not specified in the distribution destination specification file at step S404, the copy number setting module 24 obtains the paper size for printing set by the user from the print job data, which is stored in the buffer module 31 at step S104 in the flowchart of FIG. 4 (step 5408). The paper size, as well as the QT value, is written in the job control language section of the print job data.

The copy number setting module 24 utilizes SNMP or another adequate protocol via the LAN to make a first inquiry about the number of paper trays to the respective distribution destination printers specified at step S110 in the flowchart of FIG. 4, receive responses to the first inquiry, and make a second inquiry about the paper sizes set in the respective paper trays and the presence or the absence of papers in the respective paper trays, and receive responses to the second inquiry (step S410). The printer generally has the functions of monitoring the paper sizes and the presence or absence of papers set in the respective paper trays. Each distribution destination printer thus immediately gives information on the paper sizes and the presence or absence of papers set in the respective paper trays in response to the inquiries made by the copy number setting module 24.

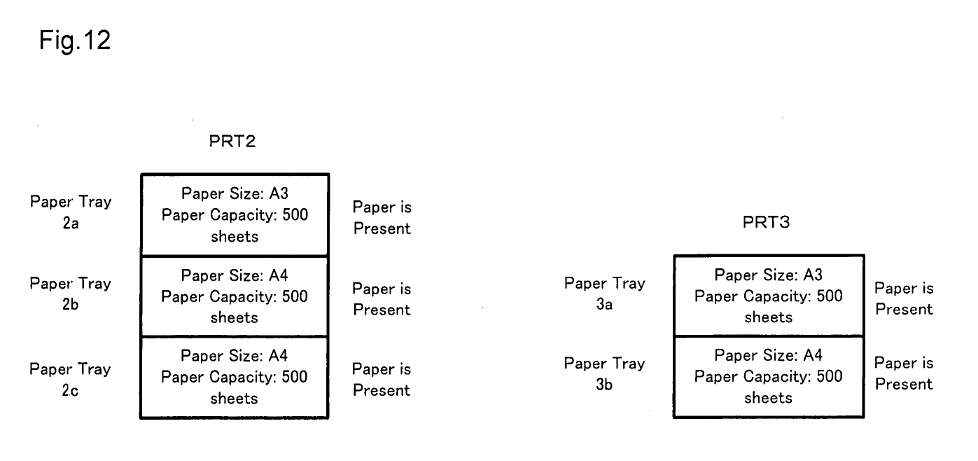

For example, the printers PRT2 and PRT3 shown in FIG. 1 are specified as distribution destination printers at step S110 in the flowchart of FIG. 4. These specified printers PRT2 and PRT3 have papers set in paper trays as shown in FIG. 12.

FIG. 12 schematically shows paper trays set in the distribution destination printers. In the illustrated example of FIG. 12, the printer PRT2 has paper trays 2a, 2b, and 2c, while the printer PRT3 has paper trays 3a and 3b. The printer PRT2 and the printer PRT3 respectively send back the number ‘3’ and the number ‘2’ in response to the first inquiry (the number of paper trays) made by the copy number setting module 24. In the printer PRT2, the paper size set in the paper tray 2a is the size ‘A3’ and the paper size set in the paper trays 2b and 2c is the size ‘A4’. Papers are currently set in all these paper trays 2a to 2c. In the printer PRT3 the paper size set in the paper tray 3a is the size ‘A3’ and the paper size set in the paper tray 3b is the size ‘A4’. Papers are currently set in both the paper trays 3a and 3b. The printers PRT2 and PRT3. respectively send back the current statuses in response to the second inquiry (the paper sizes and the presence or absence of papers set in the respective paper trays) made by the copy number setting module 24.

The copy number setting module 24 calculates the maximum available number of papers of the specified paper size expected in each of the specified distribution destination printers (step S412). In this example, the paper size set by the user and obtained at step S408 is the size ‘A4’, and the specified distribution destination printers PRT2 and PRT3 have papers set in the respective paper trays as shown in FIG. 12. The copy number setting module 24 refers to the response from each of the printers PRT2 and PRT3, specifies the paper trays with papers of the paper size ‘A4’ currently set therein, and sums up the paper capacities of the specified paper trays to calculate the maximum available number of A4 papers expected in each of the printers PRT2 and PRT3. The printer PRT2 has the paper trays 2b and 2c with papers of the paper size ‘A4’ currently set therein. The paper capacities of these paper trays 2b and 2c are respectively ‘500 sheets’. Summation of these paper capacities gives ‘1000 sheets’ as the maximum available number of A4 papers expected in the printer PRT2. The printer PRT3 has the paper tray 3b with papers of the paper size ‘A4’ currently set therein. The paper capacity of this paper tray 3b is ‘500 sheets’. The maximum available number of A4 papers expected in the printer PRT3 is accordingly ‘500 sheets’.

In this embodiment, the information given by each distribution destination printer to the copy number setting module 24 does not represent the actual number of sheets currently set in each paper tray but represents only the presence or absence of papers in each paper tray. When the copy number setting module 24 receives information representing the presence of papers in one paper tray, it is still unknown whether only one sheet is set in the paper tray or the paper tray is full to its paper capacity. The procedure of this embodiment assumes that the respective paper trays are full to their paper capacities and sets the distributed copy numbers on this assumption. The maximum available number of papers of the specified paper size expected in one distribution destination printer is accordingly the total of the paper capacities on the assumption that the respective paper trays with papers of the specified paper size are full to their paper capacities.

The copy number setting module 24 then sets the distributed copy numbers to be distributed to the respective distribution destination printers, based on the total number of print copies obtained at step S108 in the flowchart of FIG. 4 and the maximum available numbers of papers of the specified paper size expected in the respective distribution destination printers (step S414). The sum of the distributed copy numbers should naturally be equal to the required total number of print copies.

The maximum available number of A4 papers in the printer PRT2 is ‘1000 sheets’, while the maximum available number of A4 papers in the printer PRT3 is half, that is, ‘500 sheets’. When the total number of print copies obtained at step S108 is ‘180 copies’, the copy number setting module 24 sets ‘120 copies’ to the distributed copy number to be distributed to the printer PRT2 and ‘60 copies’ to the distributed copy number to be distributed to the printer PRT3. In this manner, the copy number setting module 24 sets the distributed copy numbers to be distributed to the specified distribution destination printers according to the maximum available numbers of papers of the specified paper size expected in the respective distribution destination printers. The less distributed copy number is set to the printer having the less maximum available number of papers of the specified paper size, while the greater distributed copy number is set to the printer having the greater maximum available number of papers of the specified paper size.

In general, the copy number setting module 24 sets a distributed copy number ax to be distributed to an x-th printer among ‘s’ distribution destination printers according to Equation (4) given below, where ‘m’ denotes the total number of print copies and px denotes the maximum available number of papers of the specified paper size in the x-th printer:

$${a}_{x} = m \times ( \frac{{p}_{x}}{{\sum }_{x = 1}^{s} {p}_{x}} ) \qquad ( 4 )$$

The total number of print copies and the maximum available numbers of papers of the specified paper size may give some remainder in the calculation of Equation (4). As in the case of the remaining quantities of toner described above, the copy number setting module 24 adequately distributes the remainder to some distribution destination printers. In any case, the distributed copy numbers should be set to make the sum of the distributed copy numbers to be distributed to the respective distribution destination printers equal to the required total number of print copies ‘m’.

After the copy number setting module 24 sets the distributed copy numbers to be distributed to the respective distribution destination printers, the distribution processing module 25 changes the settings of only the QT value in the print job data stored in the buffer module 31 to the distributed copy numbers to be distributed to the respective distribution destination printers and sends the print job data with the changed settings to the respective distribution destination printers at step S114 in the flowchart of FIG. 4.

The other series of processing executed in the fourth embodiment is identical with the processing of the first embodiment or the second embodiment and is not specifically described here.

D2. Effects of Embodiment

As described above, the technique of the fourth embodiment sets the distributed copy numbers to be distributed to the specified distribution destination printers according to the maximum available numbers of papers of the specified paper size expected in the respective distribution destination printers. The less distributed copy number is set to the printer having the less maximum available number of papers of the specified paper size, while the greater distributed copy number is set to the printer having the greater maximum available number of papers of the specified paper size. This arrangement effectively reduces the possibility that any distribution destination printer runs out of paper and can not complete printing after the start of distributed printing, thus ensuring efficient use of the respective distribution destination printers.

E. Fifth Embodiment

E1. System Configuration

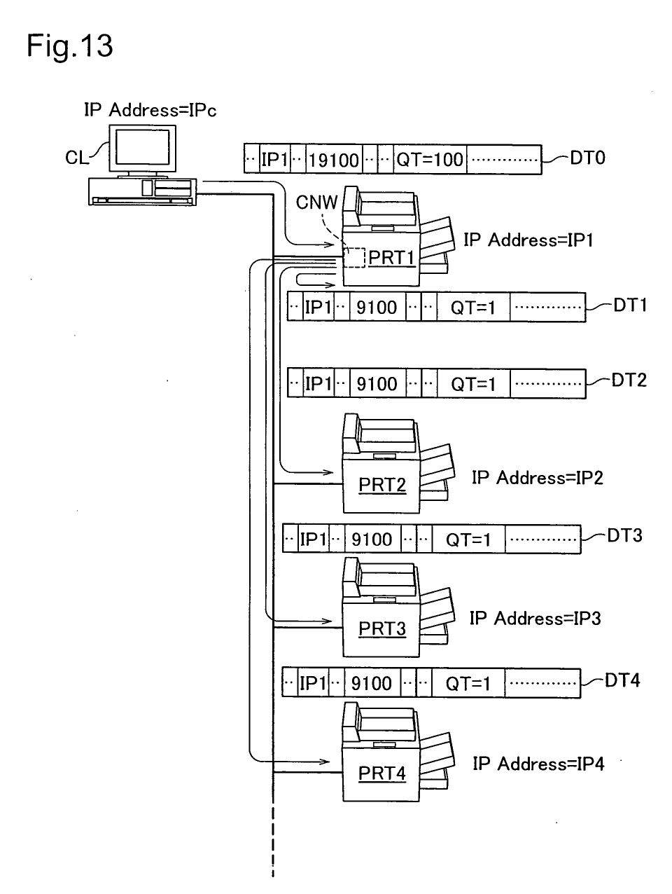

FIG. 13 schematically illustrates the configuration of a printing system including the printer PRT1 in a fifth embodiment of the invention. The configuration of this printing system is identical with that of the printing system of the first embodiment shown in FIG. 1 and is thus not specifically described here.

Referring to FIG. 13, the communication data DT0 includes ‘IP1’ as the receiver IP address, ‘19100’ as the receiver port number, and ‘100 copies’ as the QT value (that is, the number of print copies).

The printing protocol used in this embodiment is a non-procedural protocol. A port number ‘9100’ is generally allocated to the non-procedural protocol. The technique of this embodiment, however, uses a particular port number ‘19100’ instead of the general number ‘9100’ to send the print job from the client CL to the printer PRT1 having the distributed printing control functions.

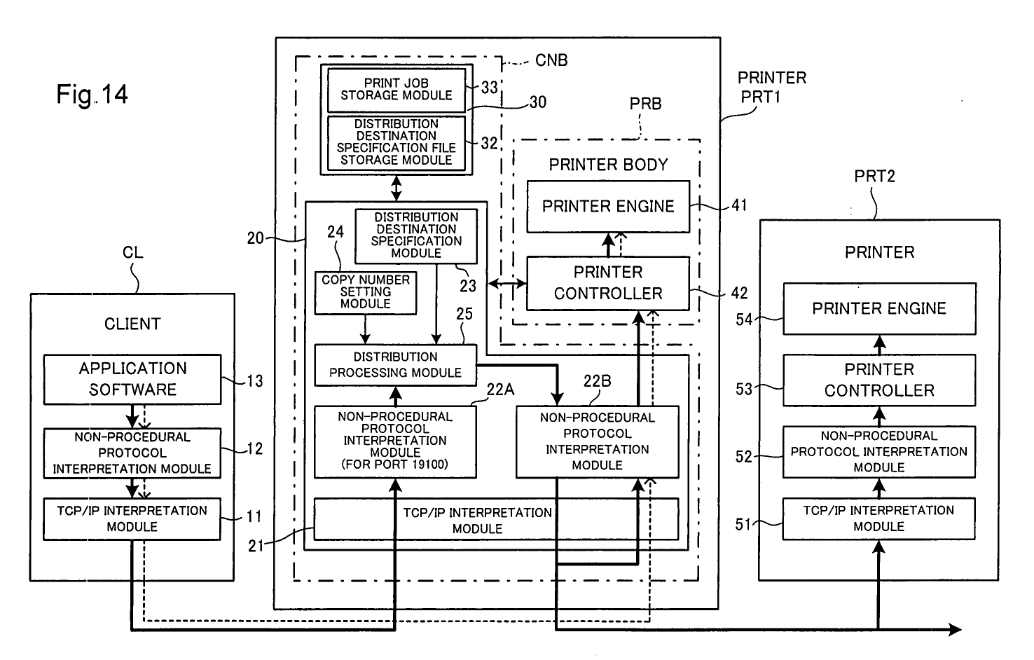

The custom network board CNB mounted on the printer PRT1 receives the communication data DT0 and transfers the print job data included in the received communication data DT0 to the software program standing by at a port having the receiver port number ‘19100’. In this embodiment, the software program standing by at the port with the port number ‘19100’ is a distributed printing software program to attain the distributed printing control functions. An internal CPU of the custom network board CNB exerts the respective functions according to the distributed printing software program. The CPU first stores the received print job data in a print job storage module 33 (see FIG. 14). In the case of complete storage of the whole print job data sent from the client CL into the print job storage module 33, the CPU retrieves printers that are in the online state but is not currently receiving nor printing any print job, among multiple printers connecting with the LAN and specifies the retrieved printers as distribution destination printers. For example, when the self printer PRT1, as well as the other printers PRT2 through PRT4 are specified as distribution destination printers, the CPU changes the QT value included in the print job data from ‘100 copies’ to ‘1 copy’ and the receiver port number from ‘19100’ to ‘9100’ and sends communication data DT1 through DT4 respectively including divisional print jobs to the specified distribution destination printers PRT1 to PRT4.

For example, the communication data DT2 includes ‘IP2’ as the receiver IP address, ‘9100’ as the receiver port number, and ‘1 copy’ as the QT value.

The standard network board mounted on the printer PRT2 receives the communication data DT2 and transfers the print job data included in the received communication data DT2 to the software program standing by at a port having the port number ‘9100’. As mentioned above, the port number ‘9100’ is generally allocated to the non-procedural printing protocol. The print job data is accordingly transferred to a print control software program in the printer PRT2, which then executes printing according to the received divisional print job.

The other printers PRT3 and PRT4 and the printer PRT1 having the distributed printing control functions similarly execute printing according to the received divisional print jobs.

Each of the printers PRT1 through PRT4 executes printing of ‘1 copy’. The printing system thus implements distributed printing of the total of ‘4 copies’.

The CPU again retrieves printers that are in the online state but is not currently receiving nor printing any print job, among the multiple printers connecting with the LAN, specifies the retrieved printers as distribution destination printers, changes the QT value included in the print job data to ‘1 copy’ and the receiver port number to ‘9100’, and sends communication data respectively including divisional print jobs to the specified distribution destination printers. Each of the distribution destination printers executes printing of ‘1 copy’. This series of processing is repeated until the accumulated number of print copies in the whole printing system reaches ‘100 copies’.

Eventually the printing system completes distributed printing of the total of ‘100 copies’.

E2. Structure of Printer

FIG. 14 mainly shows the structure of the printer PRT1 included in the printing system of FIG. 13. The printer PRT1 of this embodiment includes a printer body PRB and the custom network board CNB and has a similar structure to that of the printer PRT1 of the first embodiment shown in FIG. 3. Only the different part from the structure of the first embodiment is thus described below.

The printer PRT1 of the fifth embodiment has a print job storage module 33, in place of the buffer module 31 included in the printer PRT1 of the first embodiment shown in FIG. 3. The print job storage module 33 functions to temporarily store the received print job data.

The distribution destination specification module 23 retrieves available printers for distributed printing on the LAN as possible printers of distribution destination and selects distribution destination printers among the retrieved possible printers of distribution destination.

The client CL and the printer PRT2 of the fifth embodiment shown in FIG. 14 respectively have similar structures to those of the client CL and the printer PRT2 of the first embodiment shown in FIG. 3 and are not specifically described here.

The printers PRT3 and PRT4 included in the printing system of FIG. 13 have the same structure as that of the printer PRT2 shown in FIG. 14.

E3. Distributed Printing Process

A distributed printing process of the fifth embodiment, which is characteristic of the invention, is described below. The general printing process in the fifth embodiment is identical with the general printing process in the first embodiment and is thus not specifically described here.

When the user turns on power of the printer PRT1, the printer body PRB and the custom network board CNB are activated. The distribution destination specification module 23 acquires the model name of the self printer PRT1. In the concrete procedure, the distribution destination specification module 23 specifies the IP address ‘IP1’ of the self printer PRT1 as the receiver IP address and inquires about the model name according to SNMP (Simple Network Management Protocol). The CPU 20 receives a response to the inquiry about the model name from the printer controller 42 via a bus.

On the above assumptions, in one example, a print job is sent from the client CL to the printer PRT1 and is subjected to the distributed printing by the other printers PRT2 to PRT4 as well as the self printer PRT1.

For distributed printing, the user confirms that the printing protocol is set to the non-procedural protocol in the printer driver of the client CL and changes the setting of the port number from the general number ‘9100’ to the particular number ‘19100’. In this embodiment, setting the general number ‘9100’ selects the general printing process, while setting the particular number ‘19100’ selects the distributed printing process.

When the user issues a print command including specification of ‘100 copies’ as the number of print copies to the client CL, the application software 13 in the client CL sends a print job with the setting of the QT value, which represents the number of print copies, to ‘100 copies’ via the non-procedural protocol interpretation module 12 and the TCP/IP interpretation module 11 to the printer PRT1. The non-procedural protocol interpretation module 12 sends communication data including the print job according to the non-procedural printing protocol. The TCP/IP interpretation module 11 specifies ‘IP1’ allocated to the printer PRT1 as the receiver IP address of the communication data and the particular number ‘19100’, instead of the general number ‘9100’, as the receiver port number of the communication data.

The communication data DT0 shown in FIG. 13 is then sent from the client CL to the printer PRT1. The communication data DT0 includes ‘IP1’ as the receiver IP address, ‘19100’ as the receiver port number, and ‘100 copies’ as the QT value (that is, the number of print copies).

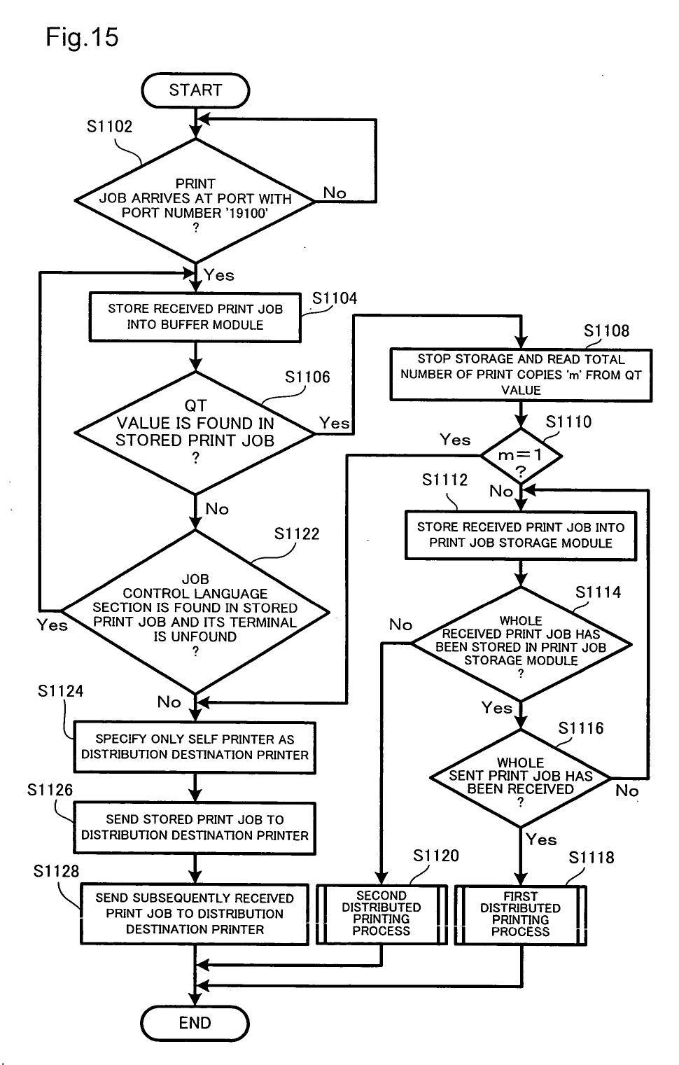

FIG. 15 is a flowchart showing a processing routine executed by the main functional blocks of the printer PRT1. More specifically this processing routine is executed by the distribution processing module 25, the distribution destination specification module 23, and the copy number setting module 24.

In the printer PRT1, the TCP/IP interpretation module 21 receives the communication data DT0 according to the receiver IP address ‘IP1’ included in the communication data DT0. Since the receiver port number included in the received communication data DT0 is ‘19100’, the TCP/IP interpretation module 21 transfers the received communication data DT0 to the non-procedural protocol interpretation module 22A that deals with communication data sent with the particular number ‘19100’, instead of the non-procedural protocol interpretation module 22B.

The distribution processing module 25 stands by until a print job arrives at a port having the particular port number ‘19100’ (step S1102). The non-procedural protocol interpretation module 22A receives the communication data including the print job and transfers the received print job data to the distribution processing module 25, which stands by at the port having the particular port number ‘19100’, according to the non-procedural protocol.

The distribution processing module 25 successively receives the print job data from its head and stores the received print job data into the print job storage module 33 (step S1104).

The distribution processing module 25 keeps storing the received print job data into the print job storage module 33 until the QT value is found in the stored print job data (step S1106). When the QT value is found, the distribution processing module 25 stops storing the print job data into the print job storage module 33 and reads the total number of print copies ‘m’ from the found QT value (step S1108). The distribution processing module 25 then determines whether the total number of print copies ‘m’ is equal to ‘1 copy’ (step S1110). When the total number of print copies ‘m’ is equal to ‘1 copy’, the program goes to step S1124. When the total number of print copies ‘m’ is not less than ‘2 copies’, on the other hand, the program goes to step S1112. Since the QT value (the number of print copies) is set equal to ‘100 copies’ in this example (‘QT=100’), the distribution processing module 25 obtains ‘100 copies’ as the total number of print copies ‘m’ and goes to step S1112 to execute distributed printing.

At step S1112, the distribution processing module 25 resumes storage of the print job data into the print job storage module 33. The distribution processing module 25 then determines whether storage of the whole received print job data into the print job storage module 33 is complete (step S1114). In the case of complete storage of the whole received print job data, the distribution processing module 25 subsequently determines whether the whole sent print job data has already been received (step S1116). When the whole print job data has not yet been received, the program returns to step S1112. The distribution processing module 25 successively stores the received print job data into the print job storage module 33 and repeats the processing of steps S1112 to S1116 until reception of the whole sent print job data. In the case of incomplete storage of the whole received print job data into the print job storage module 33 before reception of the whole sent print job data, the program goes to a second distributed printing process (step S1120). In the case of complete reception of the whole sent print job data and complete storage of the whole received print job data into the print job storage module 33, on the other hand, the program goes to a first distributed printing process (step S1118).

In the fifth embodiment, the distributed printing process shown in the flowchart of FIG. 15 is branched into the first distributed printing process and the second distributed printing process, which are selectively executed according to the complete storage or incomplete storage of the whole sent print job data into the print job storage module 33.

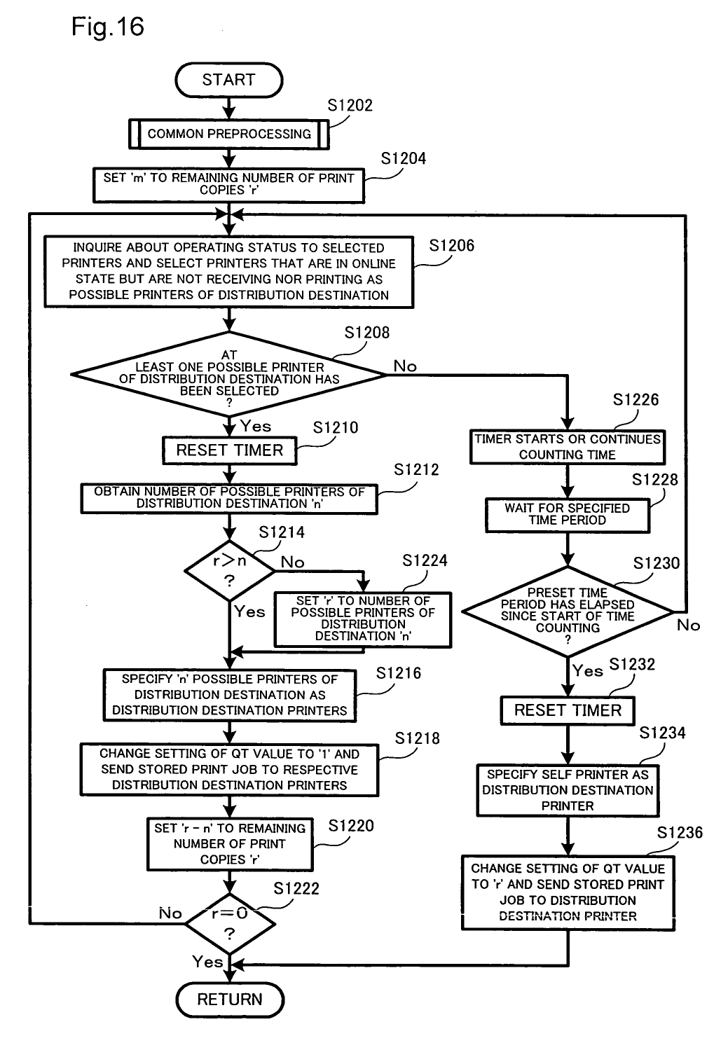

FIG. 16 is a flowchart showing the details of the first distributed printing process executed at step S1118 in the flowchart of FIG. 15. The distribution destination specification module first executes a series of common preprocessing (step S1202). This series of common preprocessing is executed not only in the first distributed printing process but in the second distributed printing process described later.

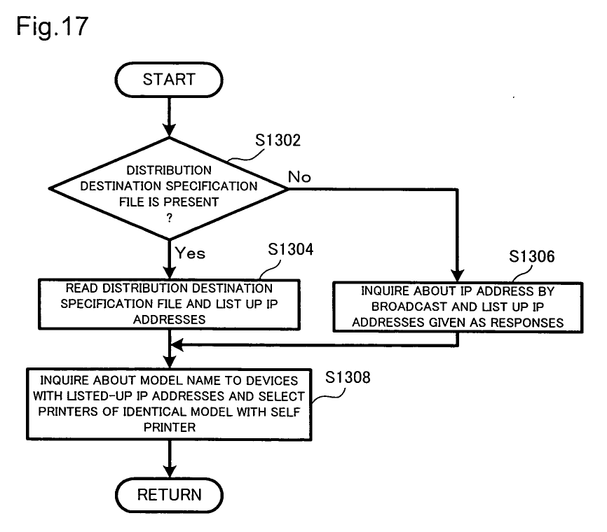

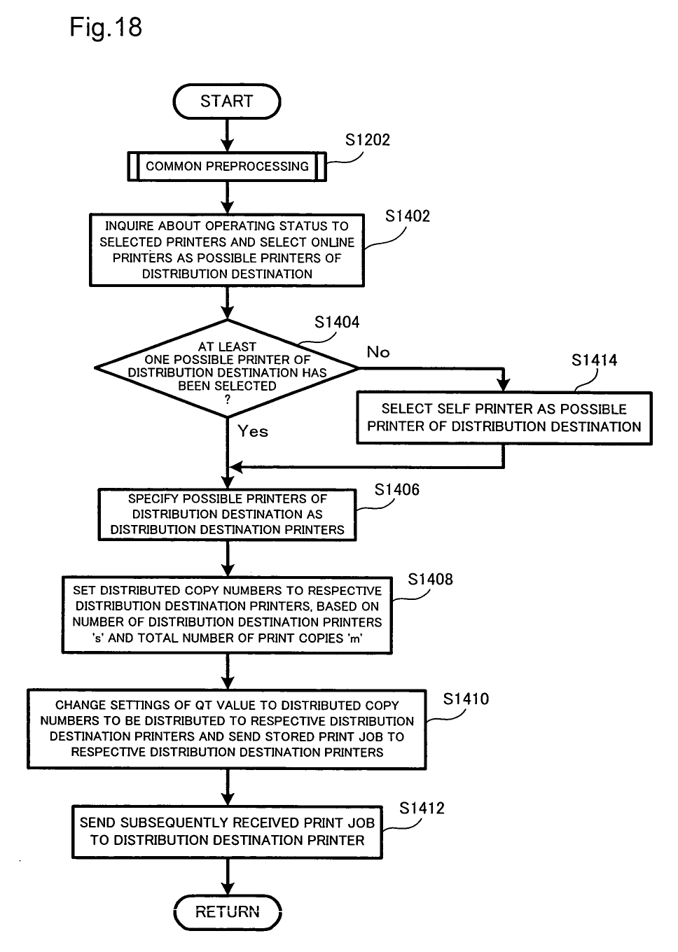

FIG. 17 is a flowchart showing the details of the common preprocessing executed at step S1202 in the flowcharts of FIGS. 16 and 18. In the common preprocessing, the distribution destination specification module 23 first detects the presence or the absence of a distribution destination specification file in the distribution destination specification file storage module 32 (step S1302). The storage of the distribution destination specification file means that desired printers have been specified in advance as possible printers of distribution destination for distributed printing.

The contents of the distribution destination specification file are identical with those shown in FIG. 7.

When the distribution destination specification file is present in the distribution destination specification file storage module 32, the distribution destination specification module 23 reads the stored distribution destination specification file to list up the IP addresses of the selected printers (step S1304).

When the distribution destination specification file is absent in the distribution destination specification file storage module 32, on the other hand, the distribution destination specification module 23 utilizes SNMP or another suitable protocol to inquire about the IP addresses of the respective devices connecting with the LAN by broadcast and lists up the IP addresses given as responses (step 1306).

The distribution destination specification module 23 utilizes SNMP to inquire about the model name to the respective devices having the listed-up IP address and selects the printers of the same model as that of the self printer PRT1 by referring to the responses on the model name (step S1308). The printers of the same model as that of the self printer PRT1 are selected as possible printers of distribution destination. Such selection enables the printers specified as distribution destinations to adequately implement distributed printing without any data conversion of the print job. This standardizes the qualities of resulting prints by the respective distribution destination printers, for example, the resolution and the font, as well as specification of color printing and duplex printing.

As mentioned previously, the distribution destination specification module 23 has already acquired the model name of the printer PRT1 at the power-on time of the printer PRT1 and selects the printers of the same model as that of the self printer PRT1 based on the acquired model name.

The inquiry about the model name is made to the devices having the IP addresses specified in the distribution destination specification file. There is still some possibility that an IP address written in the distribution destination specification file may be newly allocated to a printer of a different model from the model of the self printer PRT1 or to any non-printer device, after preparation of the distribution destination specification file. Accordingly demanded is confirmation that the specified IP addresses are still given to the printers of the same model as that of the self printer PRT1. This inquiry simultaneously confirms that the devices having the IP addresses specified in the distribution destination specification file are currently powered on to be accessible via the network.

On completion of the common preprocessing shown in the flowchart of FIG. 17, the copy number setting module 24 goes back to the processing flow of FIG. 16 and sets the total number of print copies ‘m’ obtained at step S1108 in the flowchart of FIG. 15 to a remaining number of print copies ‘r’ (step S1204). The remaining number of print copies ‘r’ represents a residual number of print copies to be printed in the whole system.

The distribution destination specification module 23 utilizes SNMP or another adequate protocol to inquire about the current operating status to the printers selected in the common preprocessing and selects printers satisfying all the three conditions as possible printers of distribution destination, based on the responses to the inquiry (step S1206):

(1) in the online state;

(2) currently not receiving any print job data; and

(3) currently not printing any print job data.

The condition (1) ‘in the online state’ excludes unavailable printers that are out of paper, out of toner, out of ink, in paper jam, or in any other trouble and are currently not ready for printing, from the possible printers of distribution destination. The condition (2) ‘currently not receiving any print job data’ means that the object printer is not currently receiving any print job data sent from the printer PRT1 or any other device, such as a computer. The condition (3) ‘currently not printing any print job data’ means that the object printer is not currently printing any received print job data. The printer that is in the online state and is currently receiving or printing any print job data may cause some error, for example, paper jam, out of paper, or out of toner, during the printing operation or on completion of the printing operation. The conditions (2) and (3) exclude printers having such a probability for errors from the possible printers of distribution destination.

When the self printer PRT1 is included in the printers selected in the common preprocessing, the self printer PRT1 satisfying all the above three conditions is selected as the possible printer of distribution destination.

The distribution destination specification module 23 then determines whether at least one printer has been selected as the possible printers of distribution destination (step S1208). In the case of selection of at least one printer, a timer (not shown) is reset (step S1210). The copy number setting module 24 counts the number of selected possible printers of distribution destination ‘n’ (step S1212) and compares the remaining number of print copies ‘r’ with the number of possible printers of distribution destination ‘n’ (step S1214). When the remaining number of print copies ‘r’ is greater than the number of possible printers of distribution destination ‘n’, the distribution destination specification module 23 specifies all the ‘n’ possible printers of distribution destination as distribution destination printers (step S1216). As mentioned previously, in the illustrated example of FIG. 13, the total of four printers, that is, the self printer PRT1 and the other printers PRT2 through PRT4 are specified as the distribution destination printers.

The first distributed printing process causes each of the specified distribution destination printers to execute distributed printing of ‘1 copy’. The distribution processing module 25 accordingly changes only the setting of the QT value in the print job data stored in the print job storage module 33 to ‘1 copy’ and sends the print job data with the changed setting of the QT value to the respective distribution destination printers (step S1218). In the illustrated example of FIG. 13, the distribution processing module 25 changes the setting of the QT value written in the print job data from ‘QT=100’ to ‘QT=1’ and sends the print job data with the changed setting of the QT value to the four distribution destination printers. In this case, the whole print job data sent from the client CL has been stored in the print job storage module 33. The whole print job data is thus sent to the respective distribution destination printers.

The distribution processing module 25 changes only the setting of the QT value included in the received print job to ‘1 copy’ and sends the received print job with the changed setting of the QT value via the non-procedural protocol interpretation module 22B and the TCP/IP interpretation module 21 to the respective distribution destination printers. The non-procedural protocol interpretation module 22B sends the communication data including the print job according to the non-procedural printing protocol. The TCP/IP interpretation module 21 specifies the IP addresses of the respective distribution destination printers as the receiver IP addresses of the communication data and the port number ‘9100’ generally allocated to the non-procedural protocol, instead of the received particular port number ‘19100’, as the receiver port number.

In the illustrated example of FIG. 13, the printers PRT1 through PRT4 are specified as the distribution destination printers. The communication data DT1 through DT4 sent to the respective distribution destination printers PRT1 through PRT4 include the settings of the receiver IP address, the receiver port number, and the QT value as:

Communication data DT1 to printer PRT1→‘IP1’, ‘9100’, ‘1 copy’

Communication data DT2 to printer PRT2→‘IP2’, ‘9100’, ‘1 copy’

Communication data DT3 to printer PRT3→‘IP3’, ‘9100’, ‘1 copy’

Communication data DT4 to printer PRT4→‘IP4’, ‘9100’, ‘1 copy’

In the printer PRT2 as one of the specified distribution destination printers, as shown in FIG. 14, the TCP/IP interpretation module 51 receives the communication data DT2 with the receiver port number ‘9100’ according to the receiver IP address ‘IP2’ included in the communication data DT2 and transfers the communication data DT2 including a print job to the non-procedural protocol interpretation module 52. The non-procedural protocol in interpretation module 52 receives the communication data including the print job and transfers the print job to the print controller 53 according to the non-procedural protocol. The printer controller 53 reads the required number of print copies ‘1 copy’ from the QT value included in the print job data and controls the printer engine 54 to print the specified number of print copies ‘1 copy’ according to the print job.

Each of the other printers PRT3 and PRT4 specified as the distribution destination printers similarly implements printing of the specified number of print copies ‘1 copy’ according to the received print job.

In the self printer PRT1 as one of the specified distribution destination printers, the TCP/IP interpretation module 21 receives the communication data DT1 according to the receiver IP address ‘IP1’ included in the communication data DT1. Since the receiver port number included in the received communication data DT1 is ‘9100’, the TCP/IP interpretation module 21 transfers the communication data DT1 including a print job to the non-procedural protocol interpretation module 22B that deals with communication data sent with the general port number ‘9100’ in the same manner as the general printing process. The non-procedural protocol interpretation module 22B receives the communication data including the print job and transfers the print job to the printer controller 42 according to the non-procedural protocol. The printer controller 42 reads the specified number of print copies ‘1 copy’ from the QT value included in the print job data and controls the printer engine 41 to print the specified number of print copies ‘1 copy’ according to the print job.

In this manner, the printers PRT1 through PRT4 specified as the distribution destination printers respectively implement printing of ‘1 copy’. The printing system totally implements distributed printing of ‘4 copies’. The number of copies printed by the printing system this time is accordingly equal to the number of distribution destination printers specified at step S1216, that is, the final possible printers of distribution destination ‘n’.

Referring back to the flowchart of FIG. 16, the copy number setting module 24 subtracts the number of copies ‘n’ printed this time from the remaining number of print copies ‘r’ and sets the difference to the new remaining number of print copies ‘r’ (step S1220). The copy number setting module 24 then determines whether the remaining number of print copies ‘r’ becomes equal to ‘0 copy’ (step S1222). When the remaining number of print copies ‘r’ has not yet reached ‘0 copy’, the program goes back to step S1206. The distribution destination specification module 23 again makes the inquiry about the operating status to the printers selected in the common preprocessing and selects the printers satisfying all the three conditions listed above as the possible printers of distribution destination, based on the responses.

When only little time has elapsed since transmission of the print job data at step S1218, it is highly possible that the distribution destination printers specified at step S1216 are currently receiving or printing the print job data. There is accordingly good possibility that no printer is selectable as the possible printer of distribution destination at step S1206.

In the case of failed selection of any printer as the possible printer of distribution destination (step S1208), the distribution destination specification module 23 controls the timer (not shown) to start counting time (step S1226) and waits for a specified time period, for example, 5 seconds (step S1228). The distribution destination specification module 23 then determines whether a preset time period, for example, 5 minutes, has elapsed since the start of time counting by the timer (step S1230). When the preset time period has not yet elapsed, the program returns to step S1206 to select the possible printers of distribution destination. The distribution destination specification module 23 repeats this series of processing in the preset time period until successful selection of at least one printer as the possible printer of distribution destination. During such repetition, the timer continues counting time (step S1226). While this series of processing is repeated in the preset time period, the printers that were receiving and printing the print job data may have completed the previous print job to be ready for receiving a new print job. The printers that were out of paper may have received a paper supply to be in the online state. The printers that were power off may have been powered on to be ready for printing. Such printers are then selectable as the possible printers of distribution destination.

When no printer has still been selected as the possible printer of distribution destination even after elapse of the preset time period since the start of time counting by the timer, the distribution destination specification module 23 resets the timer (step S1232) and unconditionally specifies the self printer PRT1 as the distribution destination printer (step S1234).

The distribution processing module 25 changes the QT value in the print job data stored in the print job storage module 33 to the remaining number of print copies ‘r copies’ and sends the print job data with the changed setting of the QT value to the self printer PRT1 specified as the distribution destination printer (step S1236).

The distribution processing module 25 changes the setting of only the QT value in the received print job to the ‘r copies’ and sends the received print job with the changed setting of the QT value via the non-procedural protocol interpretation module 22B and the TCP/IP interpretation module 21 to the self printer PRT1 specified as the distribution destination printer. The non-procedural protocol interpretation module 22B sends the communication data including the print job according to the non-procedural printing protocol. The TCP/IP interpretation module 21 specifies the IP address ‘IP1’ of the self printer PRT1 as the receiver IP address of the communication data and the port number ‘9100’ generally allocated to the non-procedural protocol as the receiver port number.

In the self printer PRT1 as one of the specified distribution destination printers, the TCP/IP interpretation module 21 receives the communication data DT1 according to the receiver IP address ‘IP1’ included in the communication data DT1. Since the receiver port number included in the received communication data DT1 is ‘9100’, the TCP/IP interpretation module 21 transfers the communication data DT1 including a print job to the non-procedural protocol interpretation module 22B that deals with communication data sent with the general port number ‘9100’ in the same manner as the general printing process. The non-procedural protocol interpretation module 22B receives the communication data including the print job and transfers the print job to the printer controller 42 according to the non-procedural protocol. The printer controller 42 reads the specified number of print copies ‘r copies’ from the QT value included in the print job data and controls the printer engine 41 to print the specified number of print copies ‘r copies’ according to the print job.

When no printer has been selected as the possible printer of distribution destination in the preset time period, the self printer PRT1 is specified as the distribution destination printer to implement printing of all the remaining number of print copies ‘r’. The CPU 20 then exits from the first distributed printing routine shown in the flowchart of FIG. 16.

While the series of processing from step S1206 to step S1222 is repeated, the accumulated number of copies printed in the printing system approaches to the required total number of print copies ‘m’ and the remaining number of print copies ‘r’ gradually decreases. The remaining number of print copies ‘r’ eventually becomes smaller than the number of possible printers of distribution destination ‘n’ at step S1214. In this case, all the possible printers of distribution destination are not required for the distribution destination printers, but the distribution destination printers are to be specified corresponding to the remaining number of print copies ‘r’. The distribution destination specification module 23 accordingly sets the remaining number of print copies ‘r’ to the number of possible printers of distribution destination ‘n’ (step S1224) and restricts selection of the possible printers of distribution destination to the remaining number of print copies ‘r’. The distribution destination specification module 23 then specifies the eventually selected ‘n (=r)’ possible printers of distribution destination as the distribution destination printers (step S1216).

The distribution processing module 25 changes the setting of only the QT value in the print job data stored in the print job storage module 33 to ‘1 copy’ and sends the print job data with the changed setting to the respective distribution destination printers (step S1218). The copy number setting module 24 then subtracts the number of copies ‘n’ printed this time from the remaining number of print copies ‘r’ and sets the difference to the new remaining number of print copies ‘r’ (step S1220) and determines whether the remaining number of print copies ‘r’ becomes equal to ‘0 copy’ (step S1222). Since the number of copies ‘n’ printed this time is equal to the remaining number of print copies ‘r’ (n=r), the difference obtained by subtraction of the number of printed copies ‘n’ from the remaining number of print copies ‘r’ is equal to ‘0’. The new setting of the remaining number of print copies ‘r’ is equal to ‘0 copy’. The copy number setting module 24 accordingly determines that the remaining number of print copies ‘r’ is equal to ‘0 copy’ at step S1222.

The accumulated number of copies printed by the respective distribution destination printers reaches ‘m copies’ in the whole printing system. When printing of the total number of print copies ‘m’ has been completed, the CPU 20 exits from the first distributed printing routine shown in the flowchart of FIG. 16.

On completion of the first distributed printing process, the CPU 20 goes back to the processing routine of FIG. 15 and exits from the distributed printing routine of FIG. 15.

FIG. 18 is a flowchart showing the details of the second distributed printing process executed at step S1120 in the flowchart of FIG. 15. As mentioned previously, the second distributed printing process is executed in the case of incomplete storage of the whole received print job data into the print job storage module 33 before reception of the whole print job data sent from the client CL. The distribution destination specification module 23 first executes the series of common preprocessing in the same manner as the first distributed printing process (step S1202). The series of common preprocessing has been described above with reference to the flowchart of FIG. 17 and is thus not specifically described here.

The distribution destination specification module 23 then utilizes SNMP or another adequate protocol to inquire about the operating status to the printers selected in the common preprocessing and selects online printers as possible printers of distribution destination, based on the responses to the inquiry (step S1402). This excludes unavailable printers that are out of paper or in any other error and are not ready for printing, from the possible printers of distribution destination.

When the self printer PRT1 is included in the printers selected in the common preprocessing, the online self printer PRT1 is selected as the possible printer of distribution destination.

The distribution destination specification module 23 determines whether at least one printer has been selected as the possible printer of distribution destination (step S1404). In the case of selection of no printer, the distribution destination specification module 23 unconditionally selects the self printer PRT1 as the possible printer of distribution destination (step S1414).

The distribution destination specification module 23 then specifies the selected possible printers of distribution destination as the distribution destination printers (step S1406). As mentioned previously, in the illustrated example of FIG. 13, the total of four printers, that is, the self printer PRT1 and the other printers PRT2 through PRT4 are specified as the distribution destination printers.

The second distributed printing process causes each of the specified distribution destination printers to execute distributed printing of the distributed copy number. The copy number setting module 24 sets the distributed copy numbers to be distributed to the respective distribution destination printers from the number of the distribution destination printers ‘s’ and the total number of print copies ‘m’ obtained at step S1108 (step S1408). The procedure of this embodiment sets the distributed copy numbers to be distributed to the respective distribution destination printers as equally as possible. The sum of the distributed copy numbers should naturally be equal to the required total number of print copies ‘m’

In the illustrated example of FIG. 13, the number of the specified distribution destination printers is 4 and the required total number of print copies is ‘100 copies’. The distributed copy numbers to be distributed to the respective distribution destination printers are accordingly set equal to ‘25 copies’.

The number of the specified distribution destination printers and the total number of print copies naturally make it impossible to completely equalize the distributed copy numbers to be distributed to the respective distribution destination printers. Based on this fact, in the same manner as the first embodiment, the copy number setting module 24 sets the distributed copy number ax to be distributed to the x-th printer among ‘s’ distribution destination printers according to Equation (1), where m denotes the total number of print copies.

The distribution processing module 25 changes the setting of only the QT value in the print job data stored in the print job storage module 33 to the distributed copy number ax to be distributed to the respective distribution destination printers and sends the print job data with the changed settings of the QT value to the respective distribution destination printers (step S1410). In the illustrated example of FIG. 13, the distributed copy numbers to be distributed to the respective distribution destination printers are all set equal to ‘25 copies’. The QT value included in the print job data is accordingly changed from ‘QT=100’ to ‘QT=25’, and the print job data with the changed settings of the QT value are sent to the four distribution destination printers. In this case, the whole print job data sent from the client CL has not yet been stored in the print job storage module 33. The print job data stored in the print job storage module 33 among the sent print job data is accordingly sent to the respective distribution destination printers. Transmission of the print job data stored in the print job storage module 33 makes a vacancy corresponding to the storage area. The print job storage module 33 can thus receive storage of new data. The distribution processing module 25 accordingly resumes storage of the received print job data into the print job storage module 33 and successively sends print job data subsequently received and temporarily stored in the print job storage module 33 to the respective distribution destination printers (step S1412).

The distribution processing module 25 changes only the settings of the QT value included in the received print job and sends the received print job with the changed settings of the QT value via the non-procedural protocol interpretation module 22B and the TCP/IP interpretation module 21 to the respective distribution destination printers. The non-procedural protocol interpretation module 22B sends the communication data including the print job according to the non-procedural printing protocol. The TCP/IP interpretation module 21 specifies the IP addresses of the respective distribution destination printers as the receiver IP addresses of the communication data and the port number ‘9100’ generally allocated to the non-procedural protocol, instead of the received particular port number ‘19100’, as the receiver port number.

In the illustrated example of FIG. 13, the printers PRT1 through PRT4 are specified as the distribution destination printers. The communication data DT1 through DT4 sent to the respective distribution destination printers PRT1 through PRT4 include the settings of the receiver IP address, the receiver port number, and the QT value as:

Communication data DT1 to printer PRT1→‘IP1’, ‘9100’, ‘25 copies’

Communication data DT2 to printer PRT2→‘IP2’, ‘9100’, ‘25 copies’

Communication data DT3 to printer PRT3→‘IP3’, ‘9100’, ‘25 copies’

Communication data DT4 to printer PRT4→‘IP4’, ‘9100’, ‘25 copies’

The operations of the printers PRT1 through PRT4 specified as the distribution destination printers are substantially identical with the operations in the first distributed printing process described above. The only difference is that the printer controller 53 reads the required number of print copies ‘25 copies’ from the QT value included in the print job data and controls the printer engine 54 to print the specified number of print copies ‘25 copies’ according to the print job.

In this manner, the printers PRT1 through PRT4 specified as the distribution destination printers respectively implement printing of ‘25 copies’. The printing system totally completes distributed printing of ‘100 copies’.

Each of the distribution destination printers specified at step S1406 implements distributed printing of the distributed copy number ax set at step S1408. The printing system thus totally completes printing of the required total number of print copies ‘r’. The CPU 20 accordingly exits from the second distributed printing routine shown in the flowchart of FIG. 18 and goes back to the distributed printing routine of FIG. 15 to terminate the distributed printing process.

Referring back to the flowchart of FIG. 15, when it is determined at step S1106 that the QT value is not found in the print job data stored in the print job storage module 33, the distribution processing module 25 determines whether the job control language section is found in the print job data stored in the print job storage module 33 and whether a terminal end of the job control language section has still been unfound (step S1122).

When the job control language section is not found in the stored print job data, this means that the print job data does not include the job control language section. When the QT value is not found but the job control language section is found and its terminal end has already been found, this means that the job control language section does not include the QT value. In such cases, there is no possibility of finding the QT value in the received print job data. The program accordingly proceeds to next step S1124.

As mentioned previously, when the total number of print copies ‘m’ is equal to ‘1 copy’ (step S1110), the program goes to step S1124.

At step S1124, the distribution destination specification module 23 specifies only the self printer PRT1 as the distribution destination printer. The absence of the QT value means that the required total number of print copies ‘m’ is unknown. In this case or when the total number of print copies ‘m’ represented by the QT value is equal to ‘1 copy’, the distribution processing module 25 can not substantially execute distributed printing and accordingly switches to the general printing process with only the self printer PRT1. The distribution processing module 25 sends the print job data stored in the print job storage module 33 to the self printer PRT1 specified as the distribution destination printer (step S1126). The distribution processing module 25 then successively sends the subsequently received print job data to the self printer PRT1 specified as the distribution destination printer (step S1128).

The distribution processing module 25 sends the received print job via the non-procedural protocol interpretation module 22B and the TCP/IP interpretation module 21 to the self printer PRT1. The non-procedural protocol interpretation module 22B sends the communication data including the print job according to the non-procedural printing protocol. The TCP/IP interpretation module 21 specifies the IP address ‘IP1’ of the self printer PRT1 as the receiver IP address of the communication data and the port number ‘9100’ generally allocated to the non-procedural protocol as the receiver port number.

In the self printer PRT1, the TCP/IP interpretation module 21 receives the sent communication data DT1 according to the receiver IP address ‘IP1’ included in the communication data DT1. Since the receiver port number included in the received communication data is ‘9100’, the TCP/IP interpretation module 21 transfers the communication data including a print job to the non-procedural protocol interpretation module 22B that deals with communication data sent with the general port number ‘9100’. The non-procedural protocol interpretation module 22B receives the communication data including the print job and transfers the print job to the printer controller 42 according to the non-procedural protocol. When the print job data does not include the QT value, the printer controller 42 controls the printer engine 41 to print only ‘one copy’ according to the print job. When the print job data includes the QT value, the printer controller 42 reads the specified number of print copies ‘1 copy’ from the QT value and controls the printer engine 41 to print the specified number of print copies ‘1 copy’ according to the print job. In either case, the printer PRT1 implements printing of only one copy.

As described above, when the received print job data does not include the QT value or when the required total number of print copies ‘m’ read from the QT value is only ‘1 copy’, the CPU 20 specifies the self printer PRT1 as the distribution destination printer and causes the self printer PRT1 to implement printing of only one copy. The CPU 20 then exits from the distributed printing routine of FIG. 15.

E4. Effects of Embodiment

As described above, in the printing system of the fifth embodiment, the printer PRT1 having the distributed printing control functions controls the whole distributed printing process. This simple system effectively implements distributed printing without any exclusive server.

In the printer PRT1 having the distributed printing control functions, when the whole print job data sent from the client CL has been stored in the print job storage module 33, the print job data with the changed setting of the QT value to ‘1 copy’ is sent to the respective distribution destination printers. Each of the distribution destination printers implements distributed printing of ‘1 copy’. Even when some error arises to lead to failed printing in any of the distribution destination printers, this is failure of only one copy.

When the whole received print job data has been stored in the print job storage module 33, the printer PRT1 retrieves printers that are in the online state but not currently receiving nor printing any print job data among the multiple printers connecting with the LAN and selects the retrieved printers as possible printers of distribution destination. This excludes the printers that are in the error state or the printers that may fall into the error state from the possible printers of distribution destination. This arrangement effectively prevents repeated transmission of print job data to the printer that has failed in printing.

The system of this embodiment does not require any special software program for distributed printing to be installed in the client CL. Distributed printing is achieved by simply changing the setting of the port number in the printer driver from the general port number ‘9100’ generally allocated to the non-procedural protocol to the particular port number ‘19100’. This arrangement significantly reduces the user's load.

The receiver port number in the communication data received by each distribution destination printer is the general number ‘9100’ generally allocated to the non-procedural protocol. The distribution destination printer can thus implement printing, regardless of general printing or distributed printing.

The printer PRT1 having the distributed printing control functions selectively uses the particular receiver port number ‘19100’ of the communication data as the trigger of the distributed printing control and the general receiver port number ‘9100’ of the communication data to be sent to the respective distribution destination printers. The self printer PRT1 may be specified as one of the distribution destination printers and receive the communication data with the print job sent to itself Even in this case, the port number included in the received communication data is ‘9100’, which is different from the trigger of the distributed printing control. The printer PRT1 accordingly does not infinitely redistribute the print job division distributed to itself. Similarly when multiple custom network boards having the distributed printing control functions are present in an identical network, this arrangement effectively prevents meaningless to-and-fro distribution between the multiple custom network boards.

When the print job data received and stored in the print job storage module 33 does not include the QT value or when the required total number of print copies ‘m’ read from the QT value is only ‘1 copy’, the self printer PRT1 is specified as the distribution destination printer. The printer PRT1 then immediately starts sending the print job data to the self printer PRT1. This arrangement significantly accelerates the start of printing at the distribution destination printer, compared with the conventional system that starts sending the print job data to the distribution destination printer after completion of receiving all the print job data sent from the client CL.

The printer PRT1 changes only the QT value as the print copy number information included in the received print job and sends the communication data with the changed settings of only the QT value to the respective distribution destination printers to achieve distributed printing. The CPU 20 included in the custom network board CNB is accordingly not required to have the high processing capacity. This desirably reduces the total manufacturing cost.

F. Sixth Embodiment

The technique of the fifth embodiment uses the identical non-procedural printing protocol but different port numbers, that is, the general number ‘9100’ and the particular number ‘19100’, in the process of sending the print job from the client CL to the printer PRT1 having the distributed printing control functions and in the process of sending the print job from the printer PRT1 to the specified distribution destination printers to achieve distributed printing. Like the second embodiment, the technique of a sixth embodiment uses different printing protocols in the process of sending the print job from the client CL to the printer PRT1 having the distributed printing control functions and in the process of sending the print job from the printer PRT1 to the specified distribution destination printers to achieve distributed printing.

F1. Structure of Printer

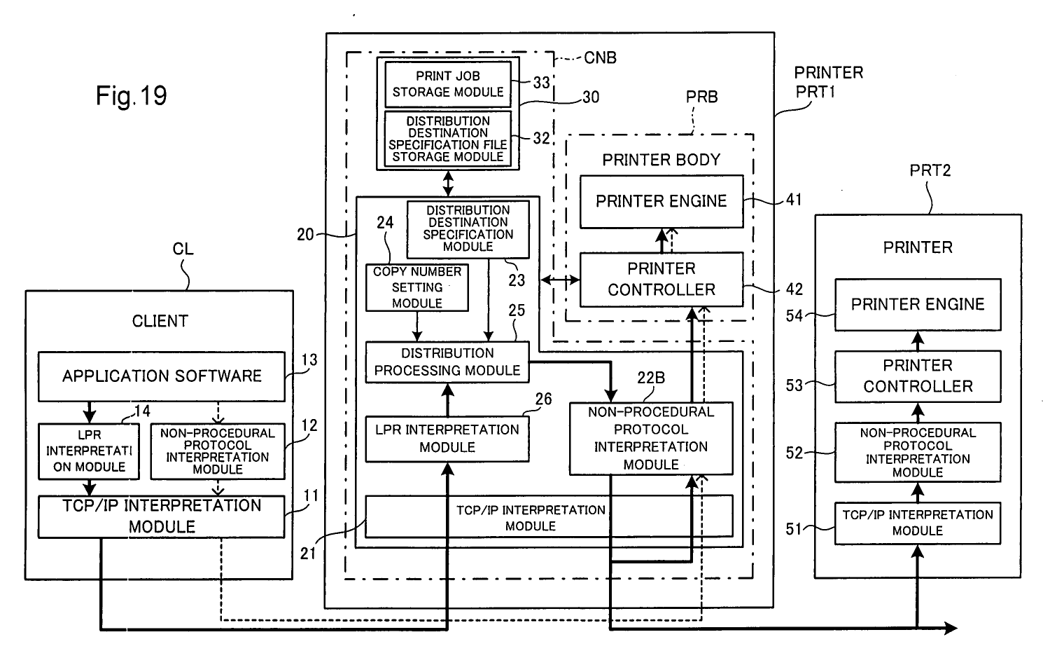

FIG. 19 mainly shows the structure of the printer PRT1 in the sixth embodiment of the invention. The structure of the printer PRT1 of the sixth embodiment shown in FIG. 19 is similar to the structure of the printer PRT1 of the fifth embodiment shown in FIG. 14, except that the non-procedural protocol interpretation module 22A is replaced by an LPR interpretation module 26 (the non-procedural protocol interpretation module 22B is kept unchanged) and that the client CL correspondingly has an LPR interpretation module 14.

F2. Distributed Printing Process

A distributed printing process of the sixth embodiment, which is characteristic of the invention, is described below. The general printing process in the sixth embodiment is identical with the general printing process in the second embodiment and is thus not specifically described here.

In order to implement distributed printing, the user changes the setting of the printing protocol from the non-procedural protocol to the LPR in the printer driver of the client CL. The technique of the sixth embodiment changes over the setting of the printing protocol to selectively execute the general printing process according to the non-procedural protocol or the distributed printing process according to the LPR.

When the user issues a print command including specification of ‘100 copies’ as the number of print copies to the client CL, the application software 13 in the client CL sends a print job with the setting of the QT value, which represents the number of print copies, to ‘100 copies’ via the LPR interpretation module 14 and the TCP/IP interpretation module 11 to the printer PRT1. The LPR interpretation module 14 sends communication data including the print job according to the printing protocol LPR. The TCP/IP interpretation module 11 specifies ‘IP1’ allocated to the printer PRT1 as the receiver IP address of the communication data.

In the printer PRT1, the TCP/IP interpretation module 21 receives the communication data according to the receiver IP address ‘IP1’ included in the communication data. The LPR interpretation module 26 receives the communication data including the print job and transfers the print job data to the distribution processing module 25 according to the printing protocol LPR.

The series of processing executed in the sixth embodiment to specify the distribution destination printers after the transfer of the print job data to the distribution processing module 25 is identical with that of the fifth embodiment and is thus not specifically described here. In this example, the printers PRT1 through PRT4 are specified as the distribution destination printers.

The distribution processing module 25 changes only the settings of the QT value included in the received print job and sends the received print job with the changed settings of the QT value via the non-procedural protocol interpretation module 22B, instead of the LPR interpretation module 26, and the TCP/IP interpretation module 21 to the respective distribution destination printers. The non-procedural protocol interpretation module 22B sends the communication data including the print job according to the non-procedural printing protocol. The TCP/IP interpretation module 21 specifies the IP addresses of the respective distribution destination printers as the receiver IP addresses of the communication data.

In the printer PRT2 as one of the specified distribution destination printers, as shown in FIG. 19, the TCP/IP interpretation module 51 receives the communication data according to the receiver IP address ‘IP2’ included in the communication data and transfers the communication data including a print job to the non-procedural protocol interpretation module 52. The non-procedural protocol interpretation module 52 receives the communication data including the print job and transfers the print job to the print controller 53 according to the non-procedural protocol. The printer controller 53 reads the required number of print copies from the QT value included in the print job data and controls the printer engine 54 to print the specified number of print copies according to the print job.

Each of the other printers PRT3 and PRT4 specified as the distribution destination printers similarly implements printing of the specified number of print copies according to the received print job.

In the self printer PRT1 as one of the specified distribution destination printers, the TCP/IP interpretation module 21 receives the communication data according to the receiver IP address ‘IP1’ included in the communication data sent to itself The non-procedural protocol interpretation module 22B receives the communication data including the print job and transfers the print job to the printer controller 42 according to the non-procedural protocol. The printer controller 42 reads the specified number of print copies from the QT value included in the print job data and controls the printer engine 41 to print the specified number of print copies according to the print job.

In this manner, the printers PRT1 through PRT4 specified as the distribution destination printers respectively implement printing of the specified number of print copies.

The other series of processing are identical with those of the fifth embodiment and are thus not specifically described here.

F3. Effects of Embodiment

As described above, in the printing system of the sixth embodiment, the printer PRT1 having the distributed printing control functions controls the whole distributed printing process, like the fifth embodiment. This simple system effectively implements distributed printing without any exclusive server.

Like the fifth embodiment, when the whole print job data sent from the client CL has been stored in the print job storage module 33, the printer PRT1 having the distributed printing control functions retrieves printers that are in the online state but not currently receiving nor printing any print job data among the multiple printers connecting with the LAN and selects the retrieved printers as possible printers of distribution destination. This excludes the printers that are in the error state or the printers that may fall into the error state from the possible printers of distribution destination. This arrangement effectively prevents repeated transmission of print job data to the printer that has failed in printing. The printer PRT1 then sends the print job data with the changed setting of the QT value to ‘1 copy’ to the respective distribution destination printers. Each of the distribution destination printers implements distributed printing of ‘1 copy’. Even when some error arises to lead to failed printing in any of the distribution destination printers, this is failure of only one copy.

The system of this embodiment does not require any special software program for distributed printing to be installed in the client CL. Distributed printing is achieved by simply changing the setting of the printing protocol in the printer driver from the non-procedural protocol to the LPR. This arrangement significantly reduces the user's load.

The printer PRT1 changes over the setting of the printing protocol between the LPR as the trigger of the distributed printing control and the non-procedural protocol used for transmission to the distribution destination printers. Even when the self printer PRT1 is specified as one of the distribution destination printers and sends the print job to itself, the non-procedural protocol selected as the printing protocol in this state is different from the trigger of the distributed printing control. This arrangement effectively prevents the printer PRT1 from infinitely redistributing the print job division distributed to itself.

The printer PRT1 changes only the QT value as the print copy number information included in the received print job and sends the communication data with the changed settings of only the QT value to the respective distribution destination printers to achieve distributed printing. The CPU 20 included in the custom network board CNB is accordingly not required to have the high processing capacity. This desirably reduces the total manufacturing cost.

G. Modifications

The embodiments discussed above are to be considered in all aspects as illustrative and not restrictive. There may be many modifications, changes, and alterations without departing from the scope or spirit of the main characteristics of the present invention.

The first and the fifth embodiments use the non-procedural protocol as the printing protocol. The non-procedural protocol may be replaced by another printing protocol that is capable of changing the port number, for example, LPR, IPP (Internet Printing Protocol), FTP (File Transfer Protocol), SMB (Server Message Black), or AppleTalk.

The second and the sixth embodiment use the combination of the LPR and the non-procedural protocol as the printing protocols. Any other combination of different printing protocols may be used for the same purpose.

In the fourth embodiment discussed above, the copy number setting module 24 makes the inquiry about the paper size and the presence or the absence of papers set in each paper tray to the respective distribution destination printers, and sets the distributed copy numbers to be distributed to the respective distribution destination printers, based on the responses to the inquiry. The distribution destination printers may have the function of detecting the number of sheets currently set in each paper tray. In this case, the copy number setting module 24 may make an inquiry about the number of sheets currently set in each paper tray to the respective distribution destination printers and set the distributed copy numbers to be distributed to the respective distribution destination printers, based on the responses to the inquiry. The copy number setting module 24 is informed of the available number of sheets actually set in each distribution destination printer. The distributed copy numbers to be distributed to the respective distribution destination printers may thus be set not to make any distribution destination printer run out of paper during distributed printing.

In the third or the fourth embodiment discussed above, the copy number setting module 24 makes the inquiry about the remaining quantity of toner or the inquiry about the presence or the absence of papers in each paper tray to the respective distribution destination printers, and sets the distributed copy numbers to be distributed to the respective distribution destination printers, based on the responses to the inquiry. The technique of the invention is, however, not restricted to such inquiries. The expendables of the printer include the rotating drum, as well as toners and papers. One possible modification may thus make an inquiry about the remaining life of the rotating drum to the respective distribution destination printers and set the distributed copy numbers to be distributed to the respective distribution destination printers, based on the responses to the inquiry. When the distribution destination printers are not laser printers but any of inkjet printers, dye sublimation printers, dot impact printers, and thermal transfer printers, another possible modification may make an inquiry about the remaining quantity of ink or the remaining quantity of ink ribbon, instead of the remaining quantity of toner and set the distributed copy numbers to be distributed to the respective distribution destination printers, based on the responses to the inquiry. Still another possible modification may make an inquiry about the used amount, the frequency of use, or the total operating time of an expendable, instead of the remaining quantity or the remaining life of the expendable, and set the distributed copy numbers to be distributed to the respective distribution destination printers, based on the responses to the inquiry.

The distributed copy numbers to be distributed to the respective distribution destination printers may be set according to the performance of the respective printers, instead of the information on the expendable of the printers. For example, the procedure may make an inquiry about the processing speed to the respective distribution destination printers and set the distributed copy numbers to be distributed to the respective distribution destination printers based on the responses to the inquiry. The less distributed copy number is set to the printer having the lower processing speed, whereas the greater distributed copy number is set to the printer having the higher processing speed. This arrangement significantly shortens the total processing time required for distributed printing in the whole printing system.

The performances of a printer are known and kept unchanged. The printer PRT1 may have information on the performances of all the possible distribution destination printers and set the distributed copy numbers to be distributed to specified distribution destination printers by referring to the information. The printer PRT1 is then not required to make any inquiry to the respective distribution destination printers.

In the first through the fourth embodiments discussed above, distributed printing may be executed only when the required total number of print copies exceeds a predetermined level. The distributed copy numbers may be set by taking into account the physical distances to the respective printers or the network topological distances to the respective printers on the basis of registered information, by taking into account the order of specification of the respective printers in the distribution destination specification file, or by taking into account the distribution ratio of copies specified in the distribution destination specification file.

In the embodiments discussed above, a fixed IP address is allocated to each device connected to the LAN. The IP address may dynamically allocated to each device by a DHCP (Dynamic Host Configuration Protocol) server. Allocation of a fixed IP address to the distribution source printer (the printer PRT1) is desirable, however, in the technique of specifying each printer with its IP address and selectively using the general port number ‘9100’ and the particular port number ‘19100’ as discussed in the first and the fifth embodiments. It is also preferable to allocate fixed IP addresses to distribution destination printers specified in the distribution destination specification file. When the distribution destination specification file is not used, IP addresses may not be fixed in advance to the respective distribution destination printers but may dynamically be allocated by the DHCP.

Allocation of a fixed IP address to the distribution source printer is desirable in the protocol that specifies each printer with its IP address. Allocation of IP addresses is, however, not required in the protocol that specifies each printer with a logic printer name, for example, SMP or AppleTalk. The protocol, such as SMP or AppleTalk, gives logic printer names to both the distribution source printer and the distribution destination printers. Specification of the logic printer names in the distribution destination specification file exerts the similar effects without the IP addresses.

In the embodiments discussed above, the distributed printing control device is constructed as the custom network board CNB built in the printer PRT1. The technique of the invention is, however, not restricted to this structure. The distributed printing control device may be provided separately from the printer PRT1 and may be connected with the printer PRT1 by wire connection, such as USB connection, IEEE1394 bus connection, parallel connection, or serial connection or wireless connection, such as Bluetooth connection, wireless LAN connection, or infrared connection.

In the embodiments discussed above, the distribution destination specification file specifies IP addresses of desired printers for distribution destination. This is, however, not restrictive at all. The distribution destination specification file may specify an allowable range of IP address for retrieval of possible printers of distribution destination.

In the embodiments discussed above, IP addresses are used for specification of the receivers, retrieval of the distribution destination printers, and specification of desired distribution destination printers in the distribution destination specification file. The IP addresses may be replaced by MAC addresses or any other IDs that unequivocally identify the respective devices.

In the first embodiment discussed above, when no printer has been selected as the possible printer of distribution destination at step S212 in the flowchart of FIG. 6, the self printer PRT1 is immediately selected as the possible printer of distribution destination at step S214. A printer of the identical model with the model of the self printer PRT1 is present on the LAN but is unselectable as the possible printer of distribution destination, since the printer is in the offline state due to out-of-paper or any other error or is powered off. In the case of failed selection of the possible printer of distribution destination at step S212, the distribution destination specification module 23 may wait for a predetermined time period and return to step S202 to repeat the series of processing. While the distribution destination specification module 23 waits for the predetermined time period, the printer may fall into the online state with a paper supply or may be powered on to be ready for printing. In this case, the printer is selectable for distributed printing in the next cycle of the processing.

In the first embodiment discussed above, the custom network board CNB acquires the model name of the self printer PRT1 at the power-on time of the printer PRT1. This is, however, not restrictive at all. Acquisition of the model name of the self printer PRT1 may be executed at any suitable time prior to the processing of step S208 in the flowchart of FIG. 6 (selection of printers of the identical model with the model of the self printer PRT1), for example, immediately before the processing of step S208.

In the fifth and the sixth embodiments discussed above, the second distributed printing process sets the distributed copy numbers to be distributed to the respective distribution destination printers as equally as possible. This method is, however, not restrictive at all. The copy number setting module 24 may utilize SNMP to make an inquiry about the remaining quantity or the presence or the absence of a selected expendable, for example, printing paper, toner, or ink, to the respective distribution destination printers and set the distributed copy numbers to be distributed to the respective distribution destination printers, based on the responses to the inquiry. The distributed copy numbers may be set by taking into account the printing speed, the frequency of use, or the operating time of the respective distribution destination printers. Distributed printing may be executed only when the required total number of print copies exceeds a predetermined level. The distributed copy numbers may be set by taking into account the physical distances to the respective printers or the network topological distances to the respective printers on the basis of registered information, by taking into account the order of specification of the respective printers in the distribution destination specification file, or by taking into account the distribution ratio of copies specified in the distribution destination specification file.

In the fifth and the sixth embodiments discussed above, the distribution destination specification module 23 specifies all of the ‘n’ selected possible printers of distribution destination as the distribution destination printers at step S1216 in the first distributed printing process of FIG. 16. Such specification is, however, not restrictive at all. For example, when there are two or more possible printers of distribution destination, only one of them may be specified as the distribution destination printer. The processing of steps S1212, S1214, and S1224 is not required in this modified procedure. The copy number setting module 24 sets (r−1) to the new remaining number of print copies ‘r’ at step S1220. In the case of selection of only one distribution destination printer among two or more possible printers of distribution destination, preferentially selected is the printer having the higher processing speed, the printer having the greater memory capacity, or the printer located closer to the self printer PRT1.

In the fifth and the sixth embodiments discussed above, when the QT value is not found in the print job data stored in the print job storage module 33, the distribution destination specification module 23 specifies only the self printer PRT1 as the distribution destination printer and sends the print job data stored in the print job storage module 33 to the self printer PRT1 specified as the distribution destination printer. This method is, however, not restrictive at all. In the case of failed retrieval of the QT value in the stored print job data, the subsequent series of processing may depend upon complete storage or incomplete storage of the whole sent print job data into the print job storage module 33.

In the case of complete storage of the whole sent print job data into the print job storage module 33, the procedure executes the series of common preprocessing shown in the flowchart of FIG. 17, utilizes SNMP or another adequate protocol to make an inquiry about the operating status to the respective printers selected as the possible printers of distribution destination, and specifies the online printers as the distribution destination printers, based on the responses to the inquiry. The procedure sends the print job data stored in the print job storage module 33 without any change to the respective specified distribution destination printers by a preset number of times registered in the self printer PRT1.

In the case of incomplete storage of the whole sent print job data into the print job storage module 33, the procedure executes the series of common preprocessing, makes an inquiry about the operating status to the respective printers selected as the possible printers of distribution destination, and specifies the online printers as the distribution destination printers, based on the responses to the inquiry. The procedure sends the print job data stored in the print job storage module 33 without any change to the respective specified distribution destination printers and successively sends the subsequently received print job data to these distribution destination printers.

This modified procedure is desirably applicable to printers that are not capable of using the QT value to specify the required number of print copies, for example, PostScript printers.

All changes within the meaning and range of equivalency of the claims are intended to be embraced therein. The scope and spirit of the present invention are indicated by the appended claims, rather than by the foregoing description.

Finally, the present application claims the priority based on Japanese Patent Application No. 2003-395417 filed on Nov. 26, 2003, Japanese Patent Application No. 2004-11418 filed on Jan. 20, 2004, and Japanese Patent Application No. 2004-20873 filed on Jan. 29, 2004, which are herein incorporated by reference.

1. A distributed printing control device that distributes a print job sent via a network to at least one distribution destination printing device specified as a distribution destination among printing devices, connecting with the network,
when the print job is sent with specification of a particular port number, the distributed printing control device distributing the print job to the at least one distribution destination printing device.

2. A distributed printing control device in accordance with claim 1, the distributed printing control device sending and distributing the print job with specification of a port number, which is different from the particular port number, to the at least one distribution destination printing device.

3. A distributed printing control device that distributes a print job sent via a network to at least one distribution destination printing device specified as a distribution destination among printing devices connecting with the network,
when the print job is sent according to a particular printing protocol, the distributed printing control device distributing the print job to the at least one distribution destination printing device.

4. A distributed printing control device in accordance with claim 3, the distributed printing control device sending and distributing the print job according to a printing protocol, which is different from the particular printing protocol, to the at least one distribution destination printing device.

5. A distributed printing control device that distributes a print job sent via a network to at least two distribution destination printing devices specified as distribution destinations among printing devices connecting with the network,
wherein the print job includes print copy number information,
when the print copy number information represents ‘n’ copies, where n is an integer of not less than 2, the distributed printing control device setting distributed copy numbers to be distributed to the at least two distribution destination printing devices, such that a sum of the distributed copy numbers is equal to the ‘n’ copies,
the distributed printing control device changing the print number copy information in the print job to settings of the distributed copy numbers and distributing the print job with the changed settings to the at least two distribution destination printing devices.

6. A distributed printing control device in accordance with claim 5, the distributed printing control device setting the distributed copy numbers to be distributed to the at least two distribution destination printing devices as equally as possible.

7. A distributed printing control device in accordance with claim 5, the distributed printing control device acquiring information on an expendable used in each of the at least two distribution destination printing devices from the at least two distribution destination printing devices and setting the distributed copy numbers based on the acquired information.

8. A distributed printing control device in accordance with claim 7, when the acquired information on the expendable represents a remaining quantity or a remaining life of the expendable, the distributed printing control device setting a greater distributed copy number to a distribution destination printing device having a greater remaining quantity or a greater remaining life of the expendable.

9. A distributed printing control device in accordance with claim 5, the distributed printing control device acquiring information on a performance of each of the at least two distribution destination printing devices and setting the distributed copy numbers based on the acquired information.

10. A distributed printing control device in accordance with claim 9, when the acquired information on the performance represents a processing speed of the distribution destination printing device, the distributed printing control device setting a greater distributed copy number to a distribution destination printing device having a higher processing speed.

11. A distributed printing control device in accordance with claim 5, the distributed printing control device, in response to reception of the print copy number information, changing settings of the print copy number information and starting distribution of the print job, even prior to completion of reception of the whole print job.

12. A distributed printing control device in accordance with claim 1, the distributed printing control device being built in or connected with at least one particular printing device among the printing devices connecting with the network.

13. A distributed printing control device in accordance with claim 12, wherein the particular printing device is selectable as the distribution destination printing device.

14. A distributed printing control device in accordance with claim 12, the distributed printing control device retrieving a printing device that is an identical model with a model of the particular printing device and is ready for printing, among the printing devices connecting with the network, and specifying the retrieved printing device as the distribution destination printing device.

15. A distributed printing control device in accordance with claim 12, the distributed printing control device having a distribution destination specification file,
the distributed printing control device retrieving a printing device that is an identical model with a model of the particular printing device and is ready for printing, in a range defined by specification in the distribution destination specification file among the printing devices connecting with the network, and specifying the retrieved printing device as the distribution destination printing device.

16. A distributed printing control device in accordance with claim 14, the distributed printing control device acquiring model information on the model of the particular printing device from the particular printing device during a time period between power-on and start of the retrieval.

17. A distributed printing control device in accordance with claim 15, the distributed printing control device acquiring model information on the model of the particular printing device from the particular printing device during a time period between power-on and start of the retrieval.

18. A distributed printing control device in accordance with claim 3, the distributed printing control device being built in or connected with at least one particular printing device among the printing devices connecting with the network.

19. A distributed printing control device in accordance with claim 18, wherein the particular printing device is selectable as the distribution destination printing device.

20. A distributed printing control device in accordance with claim 18, the distributed printing control device retrieving a printing device that is an identical model with a model of the particular printing device and is ready for printing, among the printing devices connecting with the network, and specifying the retrieved printing device as the distribution destination printing device.

21. A distributed printing control device in accordance with claim 18, the distributed printing control device having a distribution destination specification file,
the distributed printing control device retrieving a printing device that is an identical model with a model of the particular printing device and is ready for printing, in a range defined by specification in the distribution destination specification file among the printing devices connecting with the network, and specifying the retrieved printing device as the distribution destination printing device.

22. A distributed printing control device in accordance with claim 20, the distributed printing control device acquiring model information on the model of the particular printing device from the particular printing device during a time period between power-on and start of the retrieval.

23. A distributed printing control device in accordance with claim 21, the distributed printing control device acquiring model information on the model of the particular printing device from the particular printing device during a time period between power-on and start of the retrieval.

24. A printing device connecting with a network, the printing device having a built-in distributed printing control device in accordance with claim 1.

25. A printing device in accordance with claim 24, the printing device making itself selectable as a distribution destination printing device.

26. A printing device in accordance with claim 24, the printing device retrieving a printing device that is an identical model with a self model of the printing device and is ready for printing, among printing devices connecting with the network, and specifying the retrieved printing device as a distribution destination printing device.

27. A printing device in accordance with claim 24, the printing device having a distribution destination specification file,
the printing device retrieving a printing device that is an identical model with a self model of the printing device and is ready for printing, in a range defined by specification in the distribution destination specification file among printing devices connecting with the network, and specifying the retrieved printing device as a distribution destination printing device.

28. A printing device connecting with a network, the printing device having a built-in distributed printing control device in accordance with claim 3.

29. A printing device in accordance with claim 28, the printing device making itself selectable as a distribution destination printing device.

30. A printing device in accordance with claim 28, the printing device retrieving a printing device that is an identical model with a self model of the printing device and is ready for printing, among printing devices connecting with the network, and specifying the retrieved printing device as a distribution destination printing device.

31. A printing device in accordance with claim 28, the printing device having a distribution destination specification file,
the printing device retrieving a printing device that is an identical model with a self model of the printing device and is ready for printing, in a range defined by specification in the distribution destination specification file among printing devices connecting with the network, and specifying the retrieved printing device as a distribution destination printing device.

32. A printing device connecting with a network, the printing device having a built-in distributed printing control device in accordance with claim 5.

33. A printing device in accordance with claim 32, the printing device making itself selectable as a distribution destination printing device.

34. A printing device in accordance with claim 32, the printing device retrieving a printing device that is an identical model with a self model of the printing device and is ready for printing, among printing devices connecting with the network, and specifying the retrieved printing device as a distribution destination printing device.

35. A printing device in accordance with claim 32, the printing device having a distribution destination specification file,
the printing device retrieving a printing device that is an identical model with a self model of the printing device and is ready for printing, in a range defined by specification in the distribution destination specification file among printing devices connecting with the network, and specifying the retrieved printing device as a distribution destination printing device.

36. A print job distribution method that distributes a print job sent via a network to at least one distribution destination printing device specified as a distribution destination among printing devices connecting with the network,
the print job distribution method comprising the steps of:
(a) receiving communication data including the print job; and
(b) when the received communication data has specification of a particular port number, distributing the print job included in the communication data to the at least one distribution destination printing device.

37. A print job distribution method in accordance with claim 36, wherein the step (b) sends and distributes the print job with specification of a port number, which is different from the particular port number, to the at least one distribution destination printing device.

38. A print job distribution method that distributes a print job sent via a network to at least one distribution destination printing device specified distribution destination among printing devices connecting with the network,
the print job distribution method comprising the steps of:
(a) receiving the print job; and
(b) when the received print job is sent according to a particular printing protocol, distributing the print job to the at least one distribution destination printing device.

39. A print job distribution method in accordance with claim 38, wherein the step (b) sends and distributes the print job according to a printing protocol, which is different from the particular printing protocol, to the at least one distribution destination printing device.

40. A print job distribution method that distributes a print job sent via a network to at least two distribution destination printing devices specified as distribution destinations among printing devices connecting with the network,
the print job distribution method comprising the steps of:
(a) receiving the print job;
(b) when the received print job includes print copy number information and the print copy number information represents ‘n’ copies, where n is an integer of not less than 2, setting distributed copy numbers to be distributed to the at least two distribution destination printing devices, such that a sum of the distributed copy numbers is equal to the ‘n’ copies; and
(c) changing the print number copy information in the print job to settings of the distributed copy numbers and distributing the print job with the changed settings to the at least two distribution destination printing devices.

41. A print job distribution method in accordance with claim 40, wherein the step (b) acquires information on an expendable used in each of the at least two distribution destination printing devices from the at least two distribution destination printing devices and sets the distributed copy numbers based on the acquired information.

42. A print job distribution method in accordance with claim 40, wherein the step (b) acquires information on a performance of each of the at least two distribution destination printing devices and sets the distributed copy numbers based on the acquired information.

43. A computer program product that causes a distributed printing control device to distribute a print job sent via a network to at least one distribution destination printing device specified as a distribution destination among printing devices connecting with the network,
the computer program product comprising:
a first program code of receiving communication data including the print job;
a second program code of, when the received communication data has specification of a particular port number, distributing the print job included in the communication data to the at least one distribution destination printing device; and
a computer readable medium in which the first program code and the second program code are stored.

44. A computer program product that causes a distributed printing control device to distribute a print job sent via a network to at least one distribution destination printing device specified as a distribution destination among printing devices connecting with the network,
the computer program product comprising:
a first program code of receiving the print job;
a second program code of, when the received print job is sent according to a particular printing protocol, distributing the print job to the at least one distribution destination printing device; and
a computer readable medium in which the first program code and the second program code are stored.

45. A computer program product that causes a distributed printing control device to distribute a print job sent via a network to at least two distribution destination printing devices specified as distribution destinations among printing devices connecting with the network,
the computer program product comprising:
a first program code of receiving the print job;
a second program code of, when the received print job includes print copy number information and the print copy number information represents ‘n’ copies, where n is an integer of not less than 2, setting distributed copy numbers to be distributed to the at least two distribution destination printing devices, such that a sum of the distributed copy numbers is equal to the ‘n’ copies;
a third program code of changing the print number copy information in the print job to settings of the distributed copy numbers and distributing the print job with the changed settings to the at least two distribution destination printing devices; and
a computer readable medium in which the first to third program codes are stored.

46. A computer program product in accordance with claim 45, wherein the second program code acquires information on an expendable used in each of the at least two distribution destination printing devices from the at least two distribution destination printing devices and sets the distributed copy numbers based on the acquired information.

47. A computer program product in accordance with claim 45, wherein the second program code acquires information on a performance of each of the at least two distribution destination printing devices and sets the distributed copy numbers based on the acquired information.

48. A distributed printing control device that distributes a print job sent via a network to at least one distribution destination printing device specified as a distribution destination among printing devices connecting with the network,
the distributed printing control device comprising:
a print job storage module that stores the print job; and
a control module,
the control module storing the print job into the print job storage module when the print job is sent with specification of a particular port number,
in the case of complete storage of the whole sent print job into the print job storage module, the control module specifying the at least one distribution destination printing device among the printing devices connecting with the network and distributing the print job stored in the print job storage module to the specified at least one distribution destination printing device, so that each of the at least one distribution destination printing device implements printing of one copy.

49. A distributed printing control device in accordance with claim 48, wherein the control module sends and distributes the print job with specification of a port number, which is different from the particular port number, to the at least one distribution destination printing device.

50. A distributed printing control device that distributes a print job sent via a network to at least one distribution destination printing device specified as a distribution destination among printing devices connecting with the network,
the distributed printing control device comprising:
a print job storage module that stores the print job; and
a control module,
the control module storing the print job into the print job storage module when the print job is sent according to a particular printing protocol,
in the case of complete storage of the whole sent print job into the print job storage module, the control module specifying the at least one distribution destination printing device among the printing devices connecting with the network and distributing the print job stored in the print job storage module to the specified at least one distribution destination printing device, so that each of the at least one distribution destination printing device implements printing of one copy.

51. A distributed printing control device in accordance with claim 50, wherein the control module sends and distributes the print job according to a printing protocol, which is different from the particular printing protocol, to the at least one distribution destination printing device.

52. A distributed printing control device in accordance with claim 48, wherein when the print job includes print copy number information and the print copy number information represents ‘m’ copies, where m is an integer of not less than 2, the control module repeats specification of the at least one distribution destination printing device among the printing devices connecting with the network and distribution of the print job to the specified at least one distribution destination printing device until an accumulated number of copies printed by the at least one distribution destination printing device reaches the ‘m’ copies.

53. A distributed printing control device in accordance with claim 48, wherein the control module retrieves a printing device that is in an online state but is not receiving nor printing any print job among the printing devices connecting with the network as at least one possible printing device of distribution destination, and selects the at least one distribution destination printing device among the at least one possible printing device of distribution destination.

54. A distributed printing control device in accordance with claim 48, wherein in the case of incomplete storage of the whole sent print job into the print job storage module, when the print job includes print copy number information and the print copy number information represents ‘m’ copies, where m is an integer of not less than 2, the control module specifies the at least one distribution destination printing device among the printing devices connecting with the network, sets distributed copy numbers to be distributed to the at least one distribution destination printing device such that a sum of the distributed copy numbers is equal to the ‘m’ copies, and distributes the print job to the specified at least one distribution destination printing device, so that each distribution destination printing device implements printing of the distributed copy number.

55. A distributed printing control device in accordance with claim 48, the distributed printing control device being built in or connected with at least one particular printing device among the printing devices connecting with the network.

56. A distributed printing control device in accordance with claim 55, wherein the control module specifies the particular printing device as the distribution destination printing device.

57. A distributed printing control device in accordance with claim 55, wherein the control module extracts at least one printing device of an identical model with a model of the particular printing device among the printing devices connecting with the network, and selects the at least one distribution destination printing device among the extracted at least one printing device of the identical model.

58. A distributed printing control device in accordance with claim 57, the distributed printing control device having a distribution destination specification file,
wherein the control module extracts the at least one printing device of the identical model with the model of the particular printing device in a range defined by specification in the distribution destination specification file among the printing devices connecting with the network.

59. A distributed printing control device in accordance with claim 50, wherein when the print job includes print copy number information and the print copy number information represents ‘m’ copies, where m is an integer of not less than 2, the control module repeats specification of the at least one distribution destination printing device among the printing devices connecting with the network and distribution of the print job to the specified at least one distribution destination printing device until an accumulated number of copies printed by the at least one distribution destination printing device reaches the ‘m’ copies.

60. A distributed printing control device in accordance with claim 50, wherein the control module retrieves a printing device that is in an online state but is not receiving nor printing any print job among the printing devices connecting with the network as at least one possible printing device of distribution destination, and selects the at least one distribution destination printing device among the at least one possible printing device of distribution destination.

61. A distributed printing control device in accordance with claim 50, wherein in the case of incomplete storage of the whole sent print job into the print job storage module, when the print job includes print copy number information and the print copy number information represents ‘m’ copies, where m is an integer of not less than 2, the control module specifies the at least one distribution destination printing device among the printing devices connecting with the network, sets distributed copy numbers to be distributed to the at least one distribution destination printing device such that a sum of the distributed copy numbers is equal to the ‘m’ copies, and distributes the print job to the specified at least one distribution destination printing device, so that each distribution destination printing device implements printing of the distributed copy number.

62. A distributed printing control device in accordance with claim 50, the distributed printing control device being built in or connected with at least one particular printing device among the printing devices connecting with the network.

63. A distributed printing control device in accordance with claim 62, wherein the control module specifies the particular printing device as the distribution destination printing device.

64. A distributed printing control device in accordance with claim 62, wherein the control module extracts at least one printing device of an identical model with a model of the particular printing device among the printing devices connecting with the network, and selects the at least one distribution destination printing device among the extracted at least one printing device of the identical model.

65. A distributed printing control device in accordance with claim 64, the distributed printing control device having a distribution destination specification file,
wherein the control module extracts the at least one printing device of the identical model with the model of the particular printing device in a range defined by specification in the distribution destination specification file among the printing devices connecting with the network.

66. A printing device connecting with a network, the printing device having a built-in distributed printing control device in accordance with claim 48.

67. A printing device connecting with a network, the printing device having a built-in distributed printing control device in accordance with claim 50.

68. A print job distribution method that distributes a print job sent via a network to at least one distribution destination printing device specified as a distribution destination among printing devices connecting with the network,
the print job distribution method comprising the steps of:
(a) providing a print job storage module;
(b) receiving communication data including the print job;
(c) when the received communication data has specification of a particular port number, storing the print job included in the communication data into the print job storage module;
(d) determining whether storage of the whole sent print job into the print job storage module is complete or incomplete;
(e) in the case of complete storage of the whole sent print job into the print job storage module, specifying the at least one distribution destination printing device among the printing devices connecting with the network; and
(f) distributing the print job stored in the print job storage module to the specified at least one distribution destination printing device, so that each of the at least one distribution destination printing device implements printing of one copy.

69. A print job distribution method in accordance with claim 68, wherein the step (f) sends and distributes the print job with specification of a port number, which is different from the particular port number, to the at least one distribution destination printing device.

70. A print job distribution method that distributes a print job sent via a network to at least one distribution destination printing device specified as a distribution destination among printing devices connecting with the network,
the print job distribution method comprising the steps of:
(a) providing a print job storage module;
(b) receiving the print job;
(c) when the received print job is sent according to a particular printing protocol, storing the print job into the print job storage module;
(d) determining whether storage of the whole sent print job into the print job storage module is complete or incomplete;
(e) in the case of complete storage of the whole sent print job into the print job storage module, specifying the at least one distribution destination printing device among the printing devices connecting with the network; and
(f) distributing the print job stored in the print job storage module to the specified at least one distribution destination printing device, so that each of the at least one distribution destination printing device implements printing of one copy.

71. A print job distribution method in accordance with claim 70, wherein the step (f) sends and distributes the print job according to a printing protocol, which is different from the particular printing protocol, to the at least one distribution destination printing device.

72. A print job distribution method in accordance with claim 68, the print job distribution method further comprising the steps of:
(g) when the print job includes print copy number information and the print copy number information represents ‘m’ copies, where m is an integer of not less than 2, determining whether an accumulated number of copies printed by the at least one distribution destination printing device reaches the ‘m’ copies; and
(h) repeating the step (e) and the step (f) until it is determined that the accumulated number of copies reaches the ‘m’ copies.

73. A print job distribution method in accordance with claim 68, wherein the step (e) retrieves a printing device that is in an online state but is not receiving nor printing any print job among the printing devices connecting with the network as at least one possible printing device of distribution destination, and selects the at least one distribution destination printing device among the at least one possible printing device of distribution destination.

74. A print job distribution method in accordance with claim 68, the print job distribution method further comprising the steps of:
(g) when it is determined at the step (d) that storage of the whole sent print job into the print job storage module is incomplete, the print job includes print copy number information, and the print copy number information represents ‘m’ copies, where m is an integer of not less than 2, specifying the at least one distribution destination printing device among the printing devices connecting with the network;
(h) setting distributed copy numbers to be distributed to the at least one distribution destination printing device, such that a sum of the distributed copy numbers is equal to the ‘m’ copies; and
(i) distributing the print job to the specified at least one distribution destination printing device, so that each distribution destination printing device implements printing of the distributed copy number.

75. A print job distribution method in accordance with claim 70, the print job distribution method further comprising the steps of:
(g) when the print job includes print copy number information and the print copy number information represents ‘m’ copies, where m is an integer of not less than 2, determining whether an accumulated number of copies printed by the at least one distribution destination printing device reaches the ‘m’ copies; and
(h) repeating the step (e) and the step (f) until it is determined that the accumulated number of copies reaches the ‘m’ copies.

76. A print job distribution method in accordance with claim 70, wherein the step (e) retrieves a printing device that is in an online state but is not receiving nor printing any print job among the printing devices connecting with the network as at least one possible printing device of distribution destination, and selects the at least one distribution destination printing device among the at least one possible printing device of distribution destination.

77. A print job distribution method in accordance with claim 70, the print job distribution method further comprising the steps of
(g) when it is determined at the step (d) that storage of the whole sent print job into the print job storage module is incomplete, the print job includes print copy number information, and the print copy number information represents ‘m’ copies, where m is an integer of not less than 2, specifying the at least one distribution destination printing device among the printing devices connecting with the network;
(h) setting distributed copy numbers to be distributed to the at least one distribution destination printing device, such that a sum of the distributed copy numbers is equal to the ‘m’ copies; and
(i) distributing the print job to the specified at least one distribution destination printing device, so that each distribution destination printing device implements printing of the distributed copy number.

78. A computer program product that causes a distributed printing control device to distribute a print job sent via a network to at least one distribution destination printing device specified as a distribution destination among printing devices connecting with the network,
the computer program product comprising:
a first program code of receiving communication data including the print job;
a second program code of, when the received communication data has specification of a particular port number, storing the print job included in the communication data into a print job storage module included in the distributed printing control device;
a third program code of, in the case of complete storage of the whole print job into the print job storage module, specifying the at least one distribution destination printing device among the printing devices connecting with the network;
a fourth program code of distributing the print job stored in the print job storage module to the specified at least one distribution destination printing device, so that each of the at least one distribution destination printing device implements printing of one copy; and
a computer readable medium in which the first to fourth program codes are stored.

79. A computer program product in accordance with claim 78, wherein the fourth program code sends and distributes the print job with specification of a port number, which is different from the particular port number, to the at least one distribution destination printing device.

80. A computer program product that causes a distributed printing control device to distribute a print job sent via a network to at least one distribution destination printing device specified as a distribution destination among printing devices connecting with the network,
the computer program product comprising:
a first program code of receiving the print job;
a second program code of, when the received print job is sent according to a particular printing protocol, storing the print job into a print job storage module included in the distributed printing control device;
a third program code of, in the case of complete storage of the whole print job into the print job storage module, specifying the at least one distribution destination printing device among the printing devices connecting with the network;
a fourth program code of distributing the print job stored in the print job storage module to the specified at least one distribution destination printing device, so that each of the at least one distribution destination printing device implements printing of one copy; and
a computer readable medium in which the first to fourth program codes are stored.

81. A computer program product in accordance with claim 80, wherein the fourth program code sends and distributes the print job according to a printing protocol, which is different from the particular printing protocol, to the at least one distribution destination printing device.

82. A computer program product in accordance with claim 78, the computer program product further comprising:
a fifth program code of, when the print job includes print copy number information and the print copy number information represents ‘m’ copies, where m is an integer of not less than 2, repeating the third program code and the fourth program code until an accumulated number of copies printed by the at least one distribution destination printing device reaches the ‘m’ copies.

83. A computer program product in accordance with claim 78, wherein the third program code retrieves a printing device that is in an online state but is not receiving nor printing any print job among the printing devices connecting with the network as at least one possible printing device of distribution destination, and selects the at least one distribution destination printing device among the at least one possible printing device of distribution destination.

84. A computer program product in accordance with claim 78, the computer program product further comprising:
a fifth program code of, in the case of incomplete storage of the whole sent print job into the print job storage module, when the print job includes print copy number information and the print copy number information represents ‘m’ copies, where m is an integer of not less than 2, specifying the at least one distribution destination printing device among the printing devices connecting with the network;
a sixth program code of setting distributed copy numbers to be distributed to the at least one distribution destination printing device, such that a sum of the distributed copy numbers is equal to the ‘m’ copies; and
a seventh program code of distributing the print job to the specified at least one distribution destination printing device, so that each distribution destination printing device implements printing of the distributed copy number.

85. A computer program product in accordance with claim 80, the computer program product further comprising:
a fifth program code of, when the print job includes print copy number information and the print copy number information represents ‘m’ copies, where m is an integer of not less than 2, repeating the third program code and the fourth program code until an accumulated number of copies printed by the at least one distribution destination printing device reaches the ‘m’ copies.

86. A computer program product in accordance with claim 80, wherein the third program code retrieves a printing device that is in an online state but is not receiving nor printing any print job among the printing devices connecting with the network as at least one possible printing device of distribution destination, and selects the at least one distribution destination printing device among the at least one possible printing device of distribution destination.

87. A computer program product in accordance with claim 80, the computer program product further comprising:
a fifth program code of, in the case of incomplete storage of the whole sent print job into the print job storage module, when the print job includes print copy number information and the print copy number information represents ‘m’ copies, where m is an integer of not less than 2, specifying the at least one distribution destination printing device among the printing devices connecting with the network;
a sixth program code of setting distributed copy numbers to be distributed to the at least one distribution destination printing device, such that a sum of the distributed copy numbers is equal to the ‘m’ copies; and
a seventh program code of distributing the print job to the specified at least one distribution destination printing device, so that each distribution destination printing device implements printing of the distributed copy number.
